(19) United States
(12) Patent Application Publication
(10) Pub. No.: US 2002/0108115 A1
(43) Pub. Date: Aug. 8, 2002

(54) News and other information delivery system and method

(75) Inventor: Michael L. Palmer, Alexandria, VA (US)

Correspondence Address: HALE & DORR LLP, THE WILLARD OFFICE BUILDING, 1455 PENNSYLVANIA AVE, NW, WASHINGTON, DC, 20004, US

(73) Assignee: The Associated Press, Washington, DC

(21) Appl. No.: 10/006,236

(22) Filed: Dec. 10, 2001

Related U.S. Application Data
(60) Provisional application No. 60/254,110, filed on Dec. 11, 2000.

(51) Int. Cl. H04N 5/445; H04N 7/16

(52) U.S. Cl. 725/50; 725/138

(57) ABSTRACT

A news information content list may be updated dynamically by first altering the content list at a feed station server. More specifically, the content list may be altered by implementing one or more revisions thereto. The content list is comprised of an ordered sequence of stories, with each story being comprised of any one or combination of text elements, metadata, and one or more references to media objects. Next, the revisions implemented to the content list are packaged into a message and transmitted to one or more field stations. These revisions are used in updating copies of the content list at the field stations. Thus, media objects and the like are transmitted only when they are modified, not when they are included or moved in multiple other content lists. A content list at a field station is processed in a similar manner. Specifically, one or more revisions to a content list at a feed station are received via a message at a field station. The content list is comprised of an ordered sequence of stories, with each story including text elements and one or more references to media objects. Subsequently, a copy of the content list at the field station is updated by utilizing only the revisions to replace original content.

### RELATED APPLICATIONS

This application claims priority from U.S. Provisional Application 60/254,110, filed Dec. 11, 2000, to Palmer, which is incorporated herein by reference.

### TECHNICAL FIELD

The present invention relates generally to the transmission of information or data over data communications networks. More particularly, the present invention relates to the real-time or dynamic transmission of data such as original and/or updated news information including, for example, text and multimedia data (e.g., video, audio, graphic, digital, and/or streaming data) from a source such as a feed station system to one or more destinations, such as field stations.

### BACKGROUND ART

Over the last few decades, innovations in data communications technologies such as satellite communications and the Internet have dramatically altered the process for producing and broadcasting news programs and information. Modern broadcast news organizations are now capable of performing not only standard text production operations but also video and graphics productions, and on-air operations.

The production of news information generally involves text, metadata, video and other media production capabilities. Typically speaking, story production of this nature entails generating and editing of text gathered from several sources including, for example, a text archive. Video and graphics footage, on the other hand, may be used in conjunction with the text information to enhance a news broadcast. Video production generally includes generating and editing motion video for broadcasting using video information retrieved from a video archive or produced from various other sources (e.g., studio or field cameras). Similarly, graphics production may include generating and editing graphics data, such as titling and still images gathered from a variety of sources.

To prepare and deliver the components of a broadcast news production, producers or journalists monitor information sources such as news wires to develop ideas for news stories. The stories may include planned events such as scheduled press conferences, as well as unplanned events such as breaking news relating to natural disasters and the like. As such, the stories may include complete text bodies or textual descriptions for events that have been fully covered, or incomplete or empty documents, stories, or bodies of text used merely to designate a future story to be written at a later time. Thus, the stories may exist in a rough draft form and require additional editing.

In addition to text, the stories may include various media objects such as audio/video clips and/or graphics. Like the text, the media objects may include existing pre-recorded footage stored, for example, in an archive, or a reference to an object that is to be obtained or recorded at a later time. For example, the rough or initial draft of a story covering a political speech to be delivered later in the day may include references to video or audio footage that have not yet been captured, and are instead to be captured at the time of the speech.

These stories, including both the complete as well as the not-yet-finished stories, are subsequently assigned a place within a collection of stories or a content list or running order. These content lists may be used to represent, for example, an ordered newscast and typically include, in addition to the corresponding story bodies and media objects, a sequence in which the stories are to be played. During predetermined intervals during the day, the content lists, with each of its story bodies or media objects, are delivered or transmitted from a feed station to a number of field stations. From there, the field stations may determine which stories to include in their individual broadcasts. For instance, a field station is more apt to select and ultimately broadcast a story relating to its regional audience than a story concerning an event that occurred in another part of the country or world. The selected stories are then extracted along with any media objects, stored in the field station servers, and added to the individual field station running orders or content lists.

Incomplete or empty stories and/or media objects to be captured later, which may include or be represented as references to nonexistent media objects (e.g., zero duration media clips), are included within the content list to allow the field station producers to plan for upcoming stories. For example, an empty story identifying a press conference may be used to alert a field station producer of a story that will be delivered later in the day. A reference to a nonexistent media object may be used in a similar manner. Furthermore, the anticipated clip length or duration, as determined by the creator of the story, may be included with the content list. Using this information, the producer at the field station is able to budget and plan each of the broadcasts during a particular day for their viewing audience.

As unfinished stories are completed or as existing stories are edited at the feed station, it has been determined that the old stories in the content lists are replaced with the revised or new stories to reflect the revisions. Similarly, old media object versions or zero duration media objects are replaced with new or revised media objects (e.g., after an editor edits a clip to produce a final version suitable for broadcast). Furthermore, changes to the order of the stories in the content list may also be made at the feed station.

To deliver the new information and/or implement the revisions, it has been determined that the entire revised content list, along with each of the story bodies and media objects is delivered to the field station receivers. This process is repeated throughout the day with an entire content list and sequence of story bodies and media objects being transmitted during each transmission. Thus, any changes in the order or content of the stories require the entire content list to be rewritten to reflect the new sequence and/or any revisions or additions to the stories and/or media objects.

In this manner, broadcast news organizations are able to transmit broadcast news information to large networks of field stations for delivery to the end users of the information. However, it is nevertheless inefficient to transmit an entire content list and sequence of story bodies (with their associated media objects) with each transmission, especially if some of the stories have previously been transmitted. Furthermore, transmitting an entire content list with story bodies and media objects can be extremely time consuming and resource intensive. As such, a need exists for a technique where entire running orders/content lists, story bodies and/or media objects do not need to be retransmitted with each revision or addition. Furthermore, a need exists for a technique where updates or revisions to the running orders or story bodies are implemented at the field stations, optionally, dynamically or in real-time.

Several prior art techniques have not adequately addressed these needs. For example, U.S. Pat. No. 5,987,501 to Hamilton et al., incorporated herein by reference, discloses a multimedia system for retrieving media data from a server according to a TrackList provided by a client device. As depicted in prior art FIG. 1A (FIG. 4 of Hamilton et al.), the list of media objects to be used by the client is created by the client in STEP 120. The client then requests that the server create a TrackList for storing the media objects for the list in STEP 122. The order of the entries in the TrackList is determined by the order of the requests from the client. In response to the client request, the server creates a TrackList and responds to the client with an identifier that the client includes in any requests to the server in STEP 124.

Subsequently, the client sends a series of requests to open media files for media objects corresponding to the list created by the client in STEP 126. After the requests have been received, the server attempts to open the requested media objects in STEP 128 and associate them with the TrackList. If the server contains the media file identified by the client request, it returns the associated identifier to a cache (STEP 130). At that point, the media data is ready to be accessed upon a read request. Thus, the technique of Hamilton et al. loads media objects into a buffer prior to an actual client request so the requests may be fulfilled immediately upon request. Nevertheless, the technique of Hamilton et al. does not facilitate the generation of content lists or running orders at a feed station, which may be dynamically updated or revised at a client or field station.

Similarly, U.S. Pat. No. 5,987,501 to Loveman et al., incorporated herein by reference, discloses a procedure for the simultaneous storage and transmission of multimedia data using a host that requests data according to a response time from a server. As depicted in prior art FIG. 1B (FIG. 4 of Loveman et al.), a workstation of a newsroom production system sends a request to a browse server for a portion of a video clip that is being simultaneously stored in the browse server (STEP 150). The workstation then waits unit it receives portions of the encoded version from the browse server in response to its request (STEP 152). From there, the workstation receives and plays the received portions and determines when to send a next request for more portions (STEP 154). In particular, the time for sending a next request depends on both the amount of video data received and the time it took between sending the request and receiving the data.

After making such determination, the workstation sends the next request with the expectation that it will receive a new portion of the clip a predetermined amount of time before the workstation is through playing the earlier received portions (STEP 154). In STEP 158, the workstation checks whether the end of the video file has been reached. Thus, according to the procedure of Loveman et al., the workstation is able to maintain some predetermined amount of lead time. However, like the prior art reference discussed above, the technique of Loveman et al. does not facilitate the generation of content lists or running orders at a feed station, which may be dynamically updated or revised at a client or field station.

In view of the above, it has been determined that increasingly efficient techniques for generating and revising content lists are needed.

### SUMMARY OF THE INVENTION

It is a feature and an advantage of the present invention to provide a system, method, and computer readable medium containing instructions utilizable for preferably dynamically updating content lists or running orders across multiple workstations, optionally located in different geographic areas.

It is another optional feature and advantage of the present invention to provide a system, method, and computer readable medium containing instructions utilizable for implementing changes to a content list without requiring the entire content list to be rewritten to reflect a new sequence and/or any revisions or additions to the stories and/or media objects.

It is still yet another optional feature and advantage of the present invention to provide a system, method, and computer readable medium containing instructions utilizable for implementing changes to a content list where the entire running order/content list (including any story bodies, media objects, data, text, multimedia data, graphics, streaming data, and the like) does not need to be retransmitted with each revision or addition.

In one exemplary embodiment, an object and stream manager (OSM) is utilized to implement, for example, the updating features of the present invention. The OSM may include any number of components, such as, for example, an interface to a database for the provision of distribution information; an Internet client which enables delivery of content without the need for a satellite transmission system; a satellite client which may be used in conjunction with services provided by most satellite transmission vendors; and/or any number of video or other media servers. In addition, the OSM may also be utilized in conjunction with any or all of a newsroom computer system, production video servers, automation systems, and/or satellite transmission equipment.

Hence, the present invention provides a method, system, and/or computer readable medium storing computer executable instructions utilizable for implementing changes to a content list, without requiring the entire content list to be rewritten to reflect a new sequence and/or any revisions and/or additions to the stories and/or media objects. In one embodiment, the present invention includes altering the content list at a feed station server by implementing one or more revisions into the content list. Specifically, the content list may include an ordered sequence of stories, with each story including text elements, metadata, and one or more references to media objects. Subsequently, the revisions are packaged into a message. From there, the present invention contemplates transmitting the message to one or more field stations for updating the content list and associated content at the field stations.

In another embodiment, the present invention provides a method, system, and computer readable medium storing computer executable instructions for updating and/or dynamically updating a content list and associated content. This embodiment includes updating and/or transmitting one or more revisions to a content list having associated content implemented at a feed station to a content list and an associated data storage at a field station. Specifically, the content list is comprised of or indexes an ordered or predetermined sequence of data, such as news stories. In addition, each story may include text elements, metadata, and one or more references to media objects. The revisions are packaged into a message at the feed station, which in turn is transmitted to the field station. Subsequently, the invention contemplates updating a copy of the content list at the field station by utilizing only the revisions to the content list as a mechanism to replace and/or update original content.

In yet another embodiment, the present invention provides a system for dynamically updating a content list. In this embodiment, the system includes a newsroom computer system for coordinating generation and revision of news information including the content list. The content list includes an ordered sequence of stories, with each story including at least one of a text element, metadata, and one or more references to media objects. The system also includes one or more media and object servers for storing said media objects referenced by the references. In addition, the system includes an object and stream manager for managing transmission of data to one or more client servers. The transmitted data may include revisions to the ordered sequence of stories of the content list, text elements, metadata, references to media objects and media objects retrieved from the media and object servers. Furthermore, the revisions to the content list made at the newsroom computer system are packaged into a message and transmitted to the client servers for updating one or more corresponding content lists at the client servers.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

Other objects of the present invention will be evident to those of ordinary skill, particularly upon consideration of the following detailed description of the preferred embodiments.

### NOTATIONS AND NOMENCLATURE

The detailed descriptions which follow may be presented in terms of program procedures executed on computing or processing systems such as, for example, a computer or network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operation of the present invention include general purpose digital computers or similar devices.

### BRIEF DESCRIPTION OF THE DRAWINGS

FIGS. 1A and 1B illustrate prior art techniques;

FIG. 2 depicts one example of an architecture utilizable for implementing at least some of the features of the present invention;

FIGS. 3A and 3B are block diagram representations of examples of a feed station in communication with a number of field stations in accordance with the concepts of the present invention;

FIG. 4 depicts one example of a graphical user interface utilizable with embodiments of the present invention;

FIG. 5 is a block diagram representation of an example of a content list and its component parts;

FIGS. 6A and 6B are combined system and process diagrams illustrating an example of an updating and/or revising procedure of the present invention;

FIG. 7 depicts one example of a process utilizable for creating a news story or other content;

FIG. 8 depicts one example of a process utilizable for creating a story;

FIGS. 9A and 9B depict examples of processes utilizable for implementing additions and/or revisions to content lists, story bodies, and/or media objects and for transmitting the additions and/or revisions to a field station;

FIG. 10 depicts one example of a process utilizable for transmitting content and/or information;

FIG. 11 depicts one example of a process utilizable for processing media objects before transmission to field stations;

FIG. 12 depicts one example of a process performed upon receiving a file;

FIG. 13 depicts one example of a process utilizable by a graphical user interface for accessing transmitted information;

FIG. 14 depicts one example of an e-commerce process utilizable for purchasing media objects;

FIG. 15 depicts one example of a central processing unit for implementing a computer process in accordance with a computer implemented embodiment of the present invention;

FIG. 16 illustrates one example of a block diagram of internal hardware of the central processing unit of FIG. 15;

FIG. 17 illustrates another example of a block diagram of internal hardware of the central processing unit of FIG. 15; and

FIG. 18 illustrates one example of a memory medium, which may be used for storing a computer implemented process of the present invention.

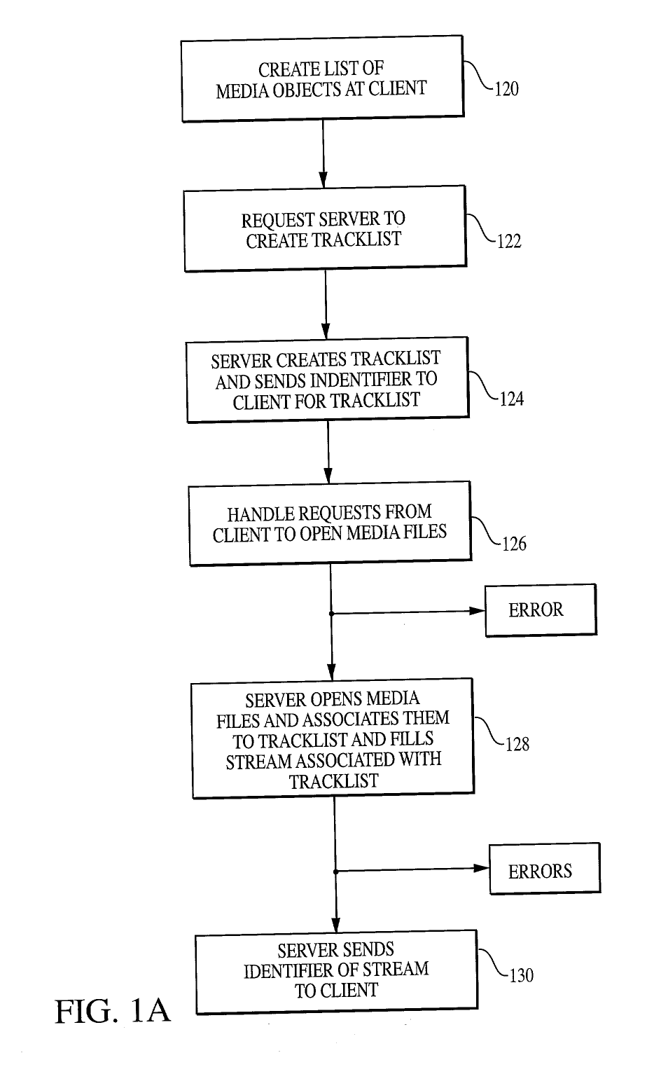

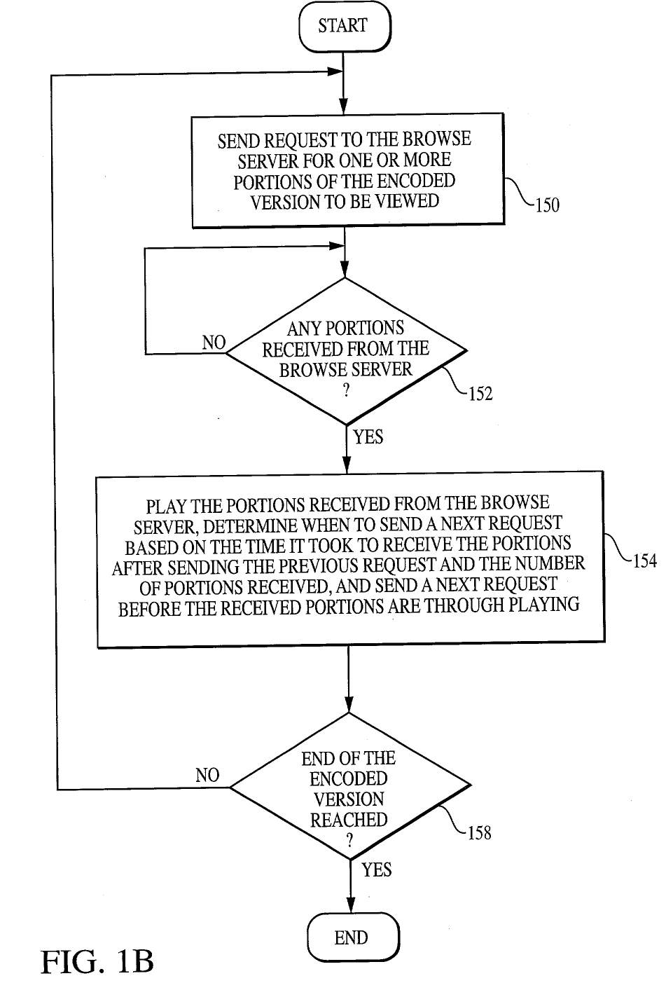

### BEST MODE FOR CARRYING OUT THE INVENTION

Reference now will be made in detail to the presently preferred embodiments of the invention. Such embodiments are provided by way of explanation of the invention, which is not intended to be limited thereto. In fact, those of ordinary skill in the art may appreciate upon reading the present specification and viewing the present drawings that various modifications and variations can be made.

For example, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

In one exemplary embodiment, an object and stream manager (OSM) is utilized to implement, for example, the updating features of the present invention. The OSM may include any number of components, such as, for example, an interface to a database for the provision of distribution information; an Internet client which enables delivery of content without the need for a satellite transmission system; a satellite client which may be used in conjunction with services provided by most satellite transmission vendors; and/or any number of video or other media servers. In addition, the OSM may also be utilized in conjunction with any or all of a newsroom computer system, production video servers, automation systems, and/or satellite transmission equipment.

One exemplary embodiment of the present invention is now summarized.

This particular embodiment upgrades current Digital Video Broadcasting (DVB) group satellite distribution systems with an integrated system for Internet Protocol (IP) delivery and short-term storage of digital file objects.

### Overall Architecture

The project is divided into three major components: Transmission System, Authoring System and Field Receivers. These three components are closely related but independent of each other.

### Example of Equipment Set

### Transmission System

1) Transport & Security

a. DVB Encoder/Multiplexer with a single backup

b. Redundant Conditional Access System

c. Redundant IP Insertion

2) Live Video

a. 5 MPEG2 Encoders (Phase Alternating Line (PAL)/National Television Standards Committee (NTSC) selectable)

3) Object Delivery

a. Ability to package multiple associated files into a single file package for transmission to the Field Receiver

b. Optional use of KenCast or SkyStream Forward Error Correction (FEC) as applied to file packages

4) Integration with Object & Stream Manager (OSM)

a. Conditional Access

b. Basic Control of MPEG2 Encoders and input

c. Priority & Scheduling of File Packages

### Authoring System

1) Object & Stream Manager (OSM)

a. Interfaces

i. Web ROX—Service & Member descriptions via psuedo MOS

ii. Transmission CAS & Encryption—Map Service & Member descriptions to PIDs and Receiver IDs

iii. File Transfer Protocol (FTP) of file objects from Media Object Servers

iv. Electronic News Production System (ENPS)—content and metadata via ActiveX & Media Object Server (MOS)

v. IP Streams—legacy functionality

vi. Wide Area Network (WAN)/Internet

b. Functions

i. Links text and object content into packages

ii. Schedules routing and delivery of packages

1. via satellite broadcast IP

2. via routed Transmission Control Protocol/Internet Protocol (TCP/IP)

iii. Manages stored content on the Field Receiver

iv. Manages activation of MPEG2 encoders

v. Manages source selection (routing) of material directed to MPEG2 encoders

vi. Reports status to OSM ActiveX & MOS Interface

vii. Receives usage data from Field Receivers

2) Media Object Servers—all file objects available via FTP interface

a. High Resolution

i. Media Exchange Format (MXF)/Advanced Authoring Format (AAF) File formats

ii. Selectable bit rate (8 Mbps nominal)

iii. MPEG2

iv. 4 audio channels

b. Low Resolution

i. Windows Media Player compatible file format

ii. Selectable bit rate (50 Kbps nominal)

iii. 1 audio channel

3) Web ROX

a. Service Description Interface

4) Journalist Interface

a. Electronic News Production System (ENPS)

i. OSM supports ENPS construction of Playlists via MOS

ii. OSM supports status reporting into Playlists via MOS

iii. Delivery priority and service description are included in RO metadata transmitted via MOS

b. OSM ActiveX Plug-In

i. Allows the journalist/manager to control basic functions (on/off/bit rate) of encoders in order to manage bandwidth

ii. Allows the journalist to select the live source routed to an encoder.

iii. Shows near real time usage of bit stream in percentage of capacity also indicated as a bar graph.

iv. Shows capacity of best case and worst-case field storage capacity of Field Receivers assigned to specific service descriptors.

### Receiver System

1) Chassis

a. 4-6 Rack Unit max

b. Integrated components

c. Auto sensing 120/240 V power supply

d. Option for control of additional external DVB Receivers

2) Control

a. Remote

b. Local—normally locked

c. Limited control via ActiveX plug in integrated with the internal HyperText Transfer Protocol (HTTP) server or newsroom system

3) Live Video

a. Variable bit rate

b. Scaleable to 4 simultaneous live DVB video signals

c. Conditional Access

4) Object Delivery

a. Via DVB Encapsulated IP

b. Via Virtual Private Network (VPN)

i. Ethernet

ii. Point-to-Point Protocol (PPP) over 56 K dial-up

c. Additional Error correction

i. Request for packet retransmission via VPN

ii. KenCast or SkyStream FEC (optionally and selectively applied to Objects)

d. File formats

i. Reception, storage and transfer of objects will be independent of file formats

5) Asset Management

a. Purges objects on demand from the OSM

b. Purges objects in FIFO fashion if capacity exceeds an administratively set threshold and notifies the OSM when this event occurs

6) Remote Administration

a. Remote Configuration

b. Remote Software Update

c. Automatic usage reporting

7) Video I/O

a. MPEG2 decoders should selectively decode either a “live” DVB stream or an MXF formatted MPEG2 file retrieved from local storage

b. MPEG2 decoder (NTSC/Pal selectable)—2nd optional

i. Composite video out

1. Configurable output level

ii. Serial Data Interface (SDI) video out

iii. 2 audio channels selectable from 6 transmitted

1. Each channel output via both

a. XLR balanced

i. Configurable output levels

b. Advanced Encryption Standard (AES)/European Broadcast Union (EBU) digital

c. 1 MPEG2 encoder (NTSC/PAL selectable)—optional

i. Composite video input

1. Configurable input level

ii. SDI video input

iii. 2 audio channels

1. Each channel input via switchable choice of

a. XLR balanced

i. Configurable input levels

b. AES/EBU digital

8) Network I/O

a. 10/100 BaseT Ethernet Network Interface Card (NIC)

b. 56K Plain Old Telephone Service (POTS) modem w/PPP support

c. Optional Gigabit Ethernet NIC

d. Optional Fiber NIC

e. FTP

i. Anonymous mechanism for exchanging file objects with other machines.

ii. The receiver is passive.

f. MOS

i. Receiver supports transmission of a number of MOS messages including mosObj, and reception of reqAll and reqMachInfo messages.

g. The receiver should support the following functions via HTTP/Web Interface

i. Listing of objects in the database

ii. Searches of the database

iii. Browse Microsoft Media compatible low resolution versions of objects

iv. Manual selection of live video channel subject to CAS

v. Manual output from the receiver of full resolution objects with optional automatic control of a tape deck via the receiver RS422 interface

vi. Conflict resolution between iv and v

9) Storage

a. 80 Gbytes or more non RAID (Redundant Array of Inexpensive Discs)

10) Serial I/O

a. RS232—Serial Agency (Wire) text output

b. RS422—Tape Machine Control (Sony protocol)

c. Optional additional RS232—Additional DVB Receiver Control

11) RF Interface

a. L-Band input for Sat Receiver components

Satellite Bandwidth is available for the invention, and equipment sets have access to full time Internet/VPN connectivity. Bandwidth will be scaled according to, for example, analysis of traffic.

### OSM Software

The OSM accepts a number of MOS messages including roCreate and roStorySend messages from the NCS (ENPS). These messages can be used to recreate content lists and stories. The lists contain order information, and the stories contain text, metadata, and object pointers (i.e., item references). Metadata will describe the service the content in the list is intended for, and optionally any clients that may be embargoed from use of the feed element. For instance, the metadata may include text, XML markup, or binary information, and the like. The OSM uses this information along with the interface to the CAS to selectively address and transmit lists, feed elements, and media objects to member field receivers.

Specifically, metadata tags are preferably embedded in the ENPS Script which is stored in Extensible Markup Language (XML) format. The OSM will use these tags to determine which service description the list contents are intended for distribution. Other tags will describe, for example, standard Intellectual Property Rights usage, and will be interpreted by the OSM as exceptions to the general distribution rule applied to the list. This allows inclusion and exclusion of specific customers and receivers.

Media Objects are retrieved by using information in MOS Item References that point to the server and file objects to be included in the feed element (story). Files may be retrieved from media object servers via FTP from a configurable static path. Alternatively, files may be captured from real-time playback of video into encoders. From there, the files may be fed from the encoders to the OSM. The MOS objID is resolved to the file name at the end of the path. The OSM does not perform file format conversion or transcoding. Low resolution (Web) versions of media objects will be retrieved using the same file name, but preferably different FTP paths.

The OSM handles packaging of media files with metadata and text files for transmission as a single packaged file to the field receiver. These files are packaged in a wrapper that is then expanded at the receiver after reception. Alternatively, the files may be transmitted one at a time.

The OSM dynamically manages asset storage in the Field Receiver, issuing remote commands to delete material in the field receiver while simultaneously reflecting changes via MOS in the NCS (ENPS). Content lists (ROs) in the NCS are advantageously dynamically linked to the field receiver so that content lists in both match at all times. One OSM communicates with another OSM via MOS and enables exchange of file objects between OSMs via FTP.

Alternatively, the assets may just as easily be managed by the field receiver. For instance, the field receivers may manage the assets automatically via rules sent to the receiver which operate on metadata contained in, for example, each RO, story, item and/or object.

Standard DVB FEC that is preferably site configurable handles error correction. DVB FEC is optionally used in conjunction with optional additional forward error correction applied to the IP data. “Carousel” redundant transmission are used and parameters associated with retransmission frequency are optionally site configurable as well. Additional KenCast or SkyStream FEC may be optionally applied to large packaged files, either through a manual selection process or through automated rules.

### Field Receiver

The field receiver is a combination of File Server, Web Server, Video DVB Receiver, and Broadband IP Receiver capable of pass through IP delivery, as well as optionally targeted file delivery. Fundamental to the architecture of the exemplary embodiment of the invention is the concept that video recorded on the integrated file server is received in the form of a file object transmitted via DVB encapsulated IP. Live video received by the box is optionally received as a DVB video stream. Receiver units optionally and advantageously are capable of simultaneously receiving multiple live video streams while also receiving and recording file objects.

The user interface for the Field Receiver is integrated via Web Server or ActiveX Control. Current generation newsrooms can use the ActiveX control as a plug-in desktop component in accordance with the present invention. Alternatively, standard web interfaces may just as easily be utilized. Legacy newsroom systems can use the ActiveX embedded in a standard Web browser. The ActiveX will allow users to select, for example, the live channel of video they wish to view, view low-resolution versions of recorded file objects, and command full resolution play out (rendering) of file objects from the box in accordance with one aspect and/or advantage of the present invention.

When not displaying a live feed or playing file objects out on command, the system automatically outputs through the video ports a playlist of objects specified to air at a specific time.

The Field Receiver is preferably MOS compatible in that it sends all messages of the mosObj category as defined by the standard MOS Protocol. A copy of the current MOS standard is attached hereto as Appendix A. The Field Receiver optionally simultaneously communicates to several machines via the MOS.

The Field Receiver optionally allows video fetched locally, either through input of live video or through FTP file transfer, to be encoded as a file for transmission from the field to the OSM. A standard ActiveX or web browser interface provides basic browse and search functionality.

The Field Receiver operates in a combination of one or more of three modes:

1)Legacy: The field receiver outputs feed material at predefined times and sequences. This output is based on the received RO/Collections that include the start time for automated play out and a list of objects. Automatic play out is subject to the following rules:

a. Automatic play out is preferably enabled through configurable setup

b. A user preference may be configurably set to give automatic play out priority over optional incoming live feeds.

i. Automatic play out will optionally not interrupt an existing live feed and will begin once the live feed ends

ii. Automatic play out will cease and be interrupted when a live feed begins

iii Optionally, users may command an override for live or automatic play out via the ActiveX or web interface

2) Alt-Tab: The field receiver is controlled via a web browser. Journalists use the Field Receiver web page or ActiveX control embedded in a web browser to browse and command the Field Receiver.

a. Scripts and other metadata are displayed by default in the ActiveX Control or web browser interface in this mode.

b. MOS messages are not sent by default in this mode.

3) Full MOS Integration: The Field Receiver ActiveX control or web page runs embedded within the NCS desktop application.

a. Journalists use the ActiveX or web page in an integrated environment. Scripts and other metadata are optionally displayed in this mode.

b. MOS messages are automatically sent.

### Object Delivery Simultaneous to Live Transmission—Exemplary Overview

A producer using ENPS writes a feed element description and inserts a mosItem reference into the story, pointing to video related to the story. This story/feed element is placed in a work running order where it is reviewed and approved for distribution.

When the story/feed element is approved for distribution it is placed (via either drag and drop or keyboard macro) into the feed running order. This feed running order is MOS Active and linked to the OSM via MOS forced running order construction. All MOS Item references in the RO are used to construct the playlist in the OSM.

The OSM receives two categories of information from ENPS. The first is the order of stories/feed elements. The second is a collection of all stories/feed elements stored as XML documents or other formats in accordance with other embodiments of the invention. These XML documents contain the descriptive text of the story/feed element, embedded mosItem pointers, and additional metadata.

The OSM examines the story/feed item XML document and extracts the mosItem pointer. The mosObjID is resolved to the file name of the object for the FTP transfer. The OSM then uses the pointer to retrieve the full and low resolution versions of the object from the file server. This is accomplished either through direct FTP of the file objects, or through automatic conversion of the object to files using, for example, a standard video encoder device or the like, such as those provided Tandberg. The OSM does a second FTP fetch of the low resolution object using the same file name, but from a different fixed path. The OSM then transmits the high resolution, low resolution, and story/feed element XML file in individual files. Alternatively, the OSM may combine these elements into a single “package” file for delivery. If only the XML file exists, it is packaged alone. If only the low resolution file object exists, then the XML file and low resolution file are both packaged. Thus, in some embodiments of the invention, the data are packaged separately, but linked using standard techniques that allow the data to be re-grouped on the destination or field station side.

After the file is packaged, the OSM manager sends the package to the internal transmission module along with metadata extracted from the story/feed XML file. The story/feed XML file is related specifically to delivery, such as service description, specific exceptions to the standard description (feed points in addition to and/or embargoed to members of the standard service description) and transmission priority. The package is then placed in a queue (one of a few) where it is sequenced according to priority described in the metadata.

The transmission module of the OSM compares the metadata descriptors with data from the ROX database and derives the appropriate conditional access descriptors which are then passed to the CAS. The CAS system then addresses and encrypts the package, which can then be transmitted in such a manner that only authorized destinations receive the package. Packages are transmitted from queues simultaneously over whatever bandwidth from the total system has been allocated to object transmission. Only one package per queue is simultaneously transmitted. For example, separate queues may be implemented for MOS messages, low resolution files, and/or high resolution files. The Field Receiver looks at the DVB stream, decrypts and extracts IP data simultaneous with optional reconstruction of at least one live MPEG2 DVB channel. The receiver is capable of receiving multiple optionally simultaneous package transmissions and writing them to disk.

To recover from any potential errors in package transmission the following error correction methods are advantageously and optionally employed:

1) “Carousel” or Delayed Retransmission: The OSM attempts to retransmit all objects at configurable times after the initial transmission, for example, 12 minutes, 40 minutes and 90 minutes from the time of initial transmission subject to the following rules:

a. The package or package contents have not been subsequently modified, deleted or superceded by a more recent package

b. Retransmission normally occurs at the lowest priority, and only when all other transmission queues are empty.

c. For each primary queue there is a matching retransmission queue. Only one object from each retransmission queue can be transmitted at a time, no matter how much bandwidth is available.

2) Request for Packet Retransmission: If a Field Receiver detects an error in a packet of a package, it preferably uses the optional TCP/IP back channel to contact the OSM and request retransmission of the single bad packet according to the following rules:

a. If the package priority is less than the highest priority, the Field Receiver waits 15 minutes for the Delayed Retransmission of the Package. If Package is not received properly, the Field Receiver sends the packet retransmission request via the TCP/IP back channel.

b. If the package priority is the highest or higher than a preset configurable threshold, then the field receiver immediately sends a packet retransmission request via the TCP/IP back channel.

3) If the OSM detects a large number of packet retransmission requests from a number of field receivers beyond a specific configurable threshold, it automatically retransmits the entire package.

4) Large packages, of a size above a configurable threshold, are automatically encoded by the OSM with the KenCast or SkyStream (or similar) FEC. If a KenCast or SkyStream encoded object fails to be received by the Field Receiver without error, the Field Receiver waits until the window for the first retransmission has passed before it immediately requests retransmission of the entire package, rather than single packets.

After receiving the package the receiver disassembles it into constituent elements. High and low resolution versions of any objects may optionally be stored on, for example, the local hard disk or other similar storage device. The XML story/feed element file is also stored. The receiver looks at the XML story/feed element file and then sends it through an XSL transform and style sheet in a manner that renders the story/feed element description in wire/agency format. This information is sent to the local NCS either through the RS232 port as serial data or via wire-by-socket. If an object was included in the package, a mosObj message is also created, and (if MOS is enabled on the receiver) transmitted to the NCS and any other defined MOS targets. This mosObj message includes the story/feed XML document in the mosExternalMetadata and mosDescription.

The field receiver preferably acknowledges all incoming mos Running order construction messages. The Field Receiver should also be capable of optionally receiving these RO Create family of messages and acting on them to either transmit objects back to the OSM or create sequenced outputs.

Users access the field receiver via an ActiveX or web page control. This control may be run within either the NCS, Internet Explorer or other standard system. The control should respond to move, size, and close commands in addition to supporting AP/ENPS recommendations for the implementation of Standard and Modal ActiveX, including the recommended use of various properties, methods, and procedures.

One embodiment of the layout for Active X control includes the following windows: Story/Feed element list; provider list; story text; media viewer; global search utility; and/or a list of content lists. The Story/Feed Element window is optionally configured only for web browser use and would preferably not be used in installations where the ActiveX is hosted in the NCS workstation. Other combinations of the above windows may optionally be used.

The provider list shows a list of all providers and the selected provider's content are displayed in the RO/Content List. The stories/feed elements in that particular RO are displayed in the Story List. If more than one media object is linked to the story/feed element, a pick list is presented in the media viewer. Clicking on the mosItem reference in the Story/Feed element viewer also causes the object to play in the media viewer. The global search utility allows a web like search of the metadata associated with each story/feed element and subsequent automatic selection of provider list/ro list/story list/and story-object viewer. Once a user identifies the desired clip, they select an option within the viewer to output the object from the AP Field Receiver's video and audio outputs. Another selection screen optionally appears before this happens, possibly warning the user of a live feed in progress or notifying the user that another user is outputting another object and that they have been placed in a queue. When an object is played, the Field Receiver optionally automatically sends the appropriate controls such as the Sony VTR controls via an interface such as the RS422 interface to command an attached VTR to record and stop. When a feed producer removes an item from the RO/Content list, the appropriate commands are sent to the Field Receivers so that the corresponding content, including media objects, is deleted.

Optionally, the OSM and Field Receiver can be remotely configured so high resolution objects will be purged from the box before on a different schedule than the low resolution and text objects. If an object is selected for which the Field Receiver does not have the high resolution version of the object the Field Receiver indicates it is attempting to retrieve the object when requested, and sends the request via the terrestrial TCP/IP back channel to the OSM which will transmit or retransmit the object.

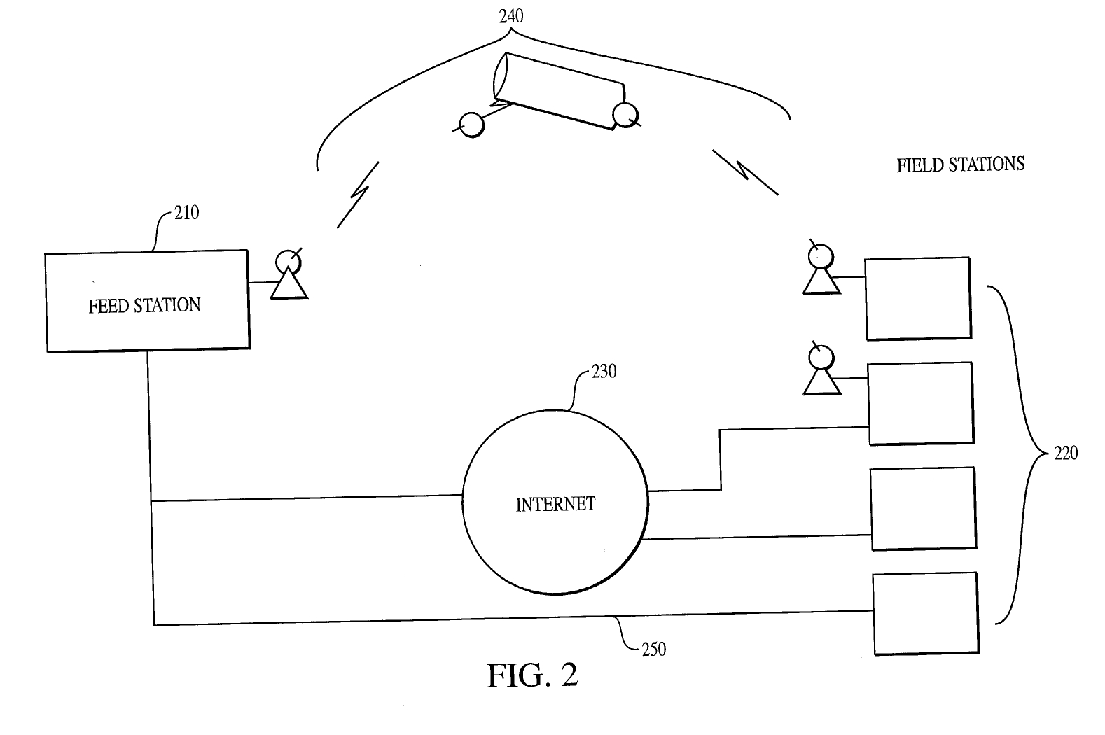

One example of an architecture utilizable for implementing at least some of the features of the present invention is depicted in FIG. 2. In this embodiment, a news organization feed station 210 is linked to one or more field stations 220 via communication networks 230, 240 and 250. The communication networks may include one or more shared data buses or point-to-point dedicated connections 250, private networks, the Internet 230, satellite networks 240 (including, for example, a live video component), and any other analogous or similar connections or network(s) or combinations thereof. As will be discussed in greater detail below, feed station 210 may be utilized to generate, store, transmit, revise and/or receive original news information and data including for example text and/or media data (e.g., video or audio data). The information transmitted by feed station 210 may be received by any number of field stations 220 via a message packaged at feed station 210. From there, field stations 220 may be used to receive, store and/or revise the information before broadcasting the information to local audiences or other end users.

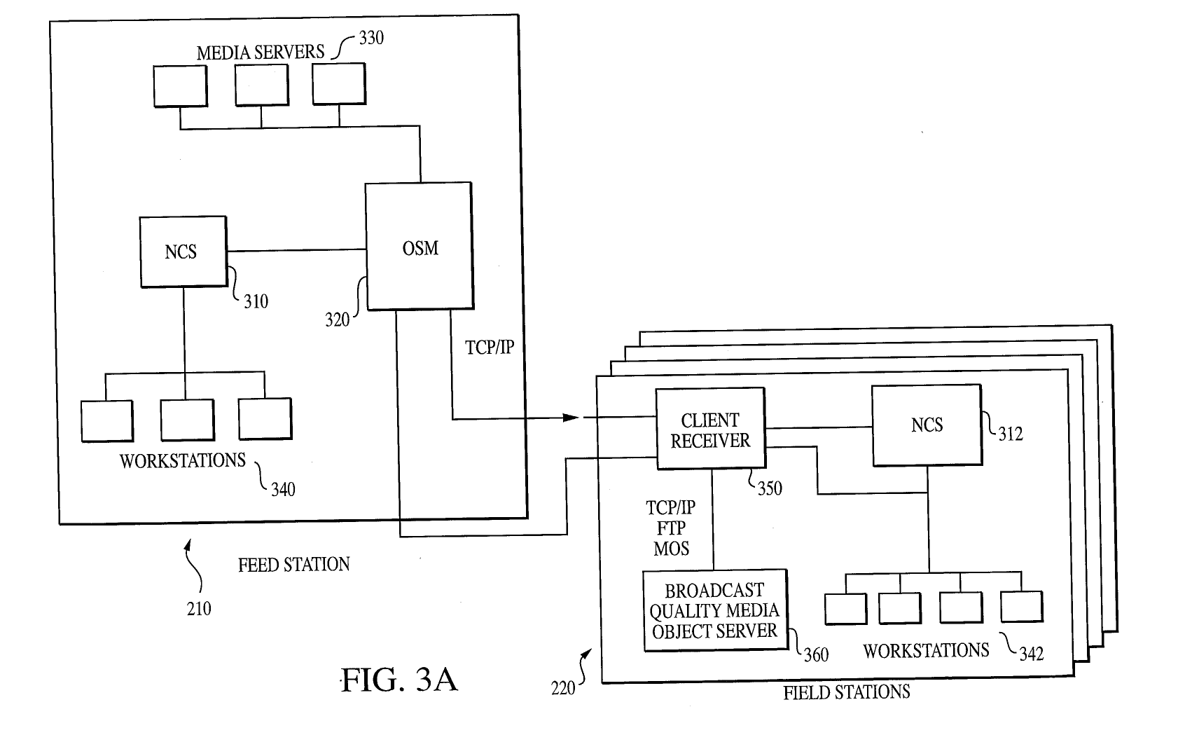

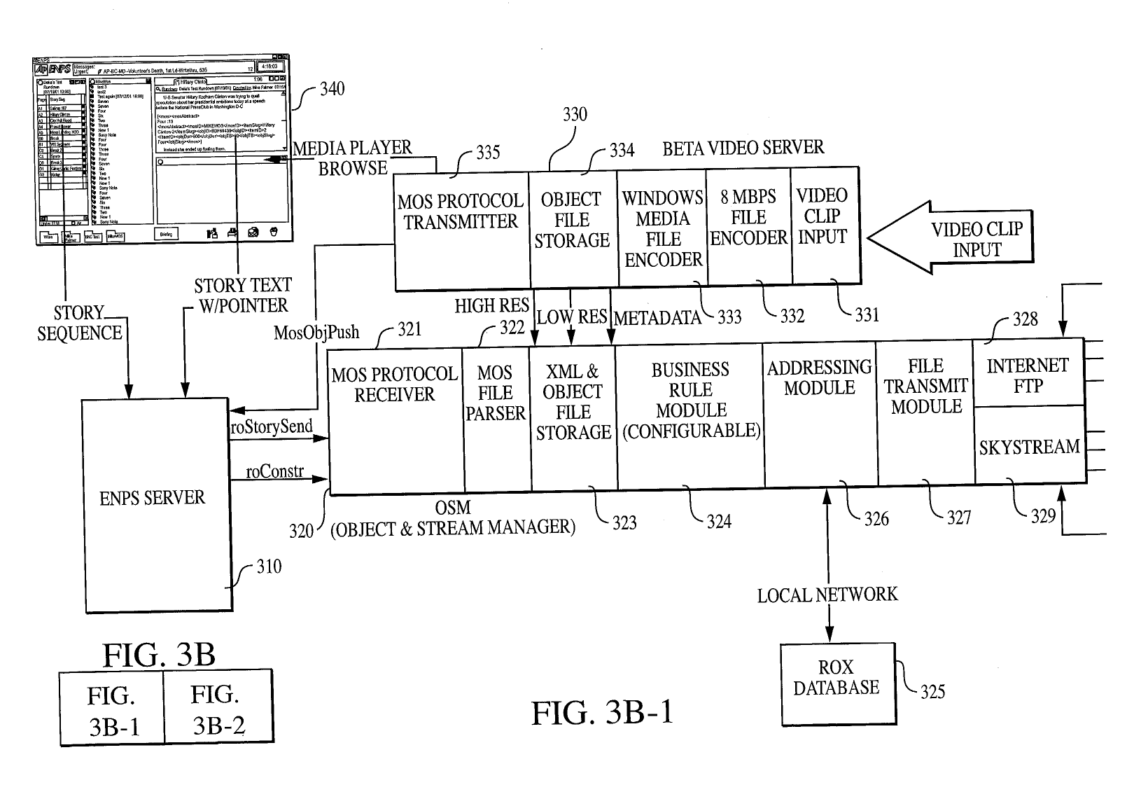

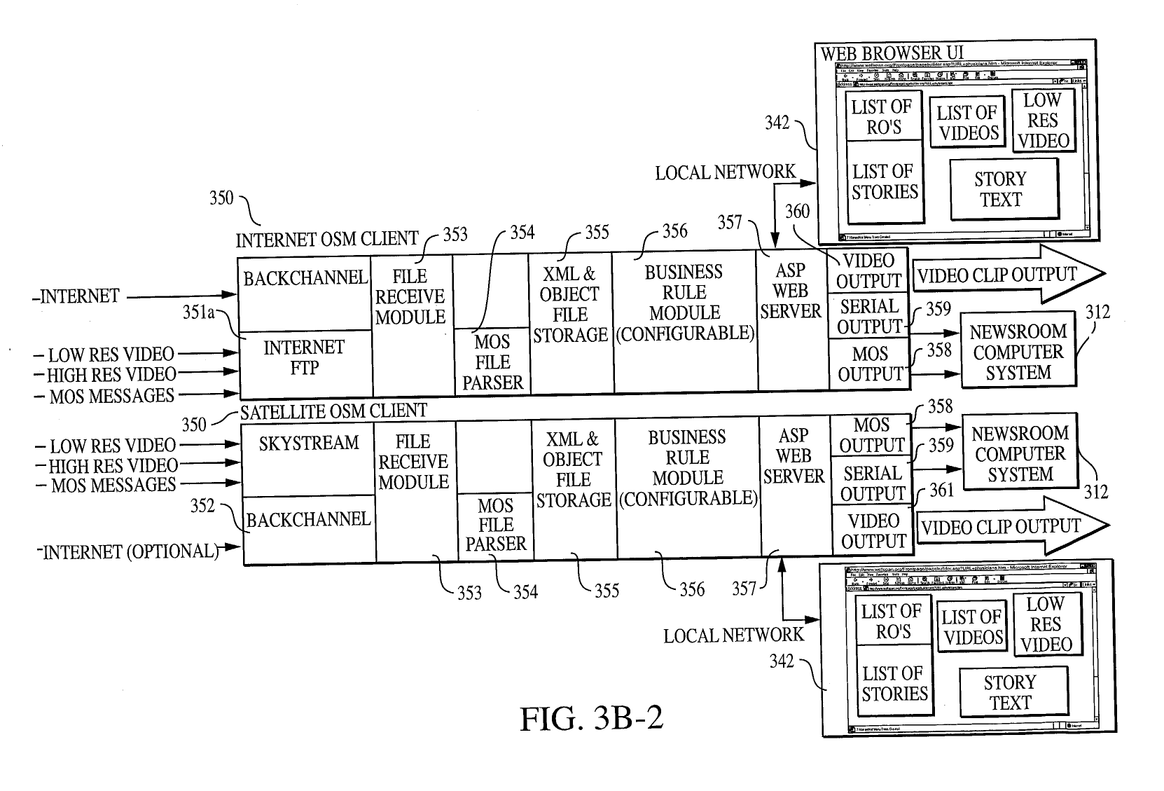

Referring to FIG. 3A, a block diagram representation of one example of a feed station in communication with a number of field stations is depicted. In this embodiment, feed station 210 includes a newsroom computer system (NCS) 310, an object and stream manager (OSM) 320, a number of media object servers (MOSs) 330, and a number of workstations 340.

NCS 310 may be utilized to coordinate the generation and receipt of original news information and the editing or revision of existing news information, to implement content lists, to store and retrieve media objects, and/or to manage the transmission of information to field stations. In one embodiment, NCS 310 includes any standard authoring technology, such as Associated Press's ENPS technology, that interfaces with a user via, for example, a user interface, and allows the user to retrieve and/or access information to be transmitted. Thus, NCS 310 is responsible for creating, in cooperation with standard authoring technology, maintaining, and updating the content lists and all of the content associated therewith.

In conjunction with NCS 310, workstations 340 may be utilized by writers (e.g., journalists or editors) to write original stories or revise existing news stories. In addition to text, the writers may also optionally include, within the stories, metadata and item references or references to media objects. As one example (as will be discussed below), these references associate a particular media object with a story. Thus, the references indicate, for example, which media objects to play during a particular story and when they are to be played. In conjunction with the generation of a story, stories may be added or removed from a running order or content list. Similarly, stories may also be moved from one position to another within the content list. Each story's position within a running order optionally indicates when the story will be presented.

The media object servers (MOSs) 330 are utilized to store media objects. As examples, MOSs 330 may accommodate video, audio, still store, live feed, and/or any other similar forms of data. More specifically, the media objects referenced by a news story are preferably stored in MOSs 330. In operation, before transmitting any media objects to feed stations 220, the objects are retrieved by OSM 320 from media object servers 330 using for example any standard file transfer protocols such as FTP and the like. For example, media objects may be retrieved using information in item references that point to the specific server and file object to be included in the story. Optionally, a standard video encoder or other similar device may be used to transcode video stored on MOS 330 in one format to a high or low resolution file of another format, which is then sent to or retrieved by OSM 320.

In accordance with the concepts of the present invention, OSM 320 is responsible for facilitating the creation of, managing, receiving, and/or storing information that is to be delivered to a destination. Specifically, OSM 320 interfaces with NCS 310 and MOSs 330, and receives content lists, news stories, optionally including the text bodies and any item references or references to media objects, metadata, and/or the media objects themselves for delivery to one or more field stations. To facilitate this delivery, in this embodiment, OSM 320 may utilize the Media Object Server Communication Protocol or the like.

As discussed above, OSM 320 manages the packaging and the dynamic delivery of information including content lists, news stories and/or media objects, in one or more files, to each of the appropriate field stations 220. In this regard, OSM 320 communicates directly with each appropriate MOS 330 to retrieve a media object. For example, low resolution and high resolution versions of video objects and/or audio objects may be transmitted from video and audio MOSs 330, and stored on OSM 320. In addition, story bodies and their order within a content list may also be stored on OSM 320. As will be discussed below, each story body may optionally include, in addition to scripts or text information, item references. Specifically, the references may include pointers to media objects stored, for example, in MOSs 330. With each reference to a media object, OSM 320 obtains a copy of the object and prepares it as a file for transmission. Subsequently, OSM 320 transmits the files, via for example TCP/IP, to field stations 220, including text information and/or any referenced media objects.

OSM 320 is optionally and advantageously also responsible for allocating bandwidth between feed station 210 and field stations 220. For example, with a connection capable of supporting a total transmission rate of 10 Mbs, where up to 8 Mbs is reserved for live transmissions, OSM 320 may be charged with allocating bandwidth between the live transmissions and the non-live file transfers. Thus, during live news events, 8 Mbs may be allocated to live video transfer (with 2 Mbs for the non-live file transfer). Similarly, when live news events are not occurring, the entire 10 Mbs may be allocated to non-live file transfers. In addition, OSM 320 is capable of providing informational feedback to a producer via for example workstations 340 regarding the transfer status of information. For instance, OSM 320 may be able to indicate the percentage of transfer completed.

In accordance with the concepts of the present invention and one embodiment of the invention, only updates or revisions to individual story bodies are transmitted by OSM 320. Similarly, updates to the order and/or content of a content list are also transmitted by OSM 320. For example, OSM 320 may transmit a command directing a field station receiver to move a story body from one position to another in the content list. Likewise, OSM 320 may be responsible for managing storage in the field stations. For example, OSM 320 may issue remote commands to delete information in the field stations to reflect changes or revisions in the feed station. Thus, changes made by, for example, a producer via workstation 340 to a content list are dynamically implemented to a content list stored in field station receiver 350 so that each instance of the content list appears identical. Accordingly, if only a portion of a story and/or other content is modified (e.g., a modified/updated story, a new media object or story, a modified content list, etc.), only the modified or new portion is packaged and transmitted to the field stations. Of course, alternative embodiments of the invention include re-transmitting an entire content list when memory and transmission capacity are not of significant concern.

Alternative embodiments of the present invention include withholding the transmission of media objects referenced in a story from a feed station to a field station until a predetermined time. For example, a producer may wish to make the field stations aware of the existence of a story, but not release any video objects until a certain predetermined time.

According to the present invention, OSM 320 may be utilized in conjunction with a conditional access component and/or an encryption component. More particularly, the conditional access component allows files to be addressed to an individual, predetermined group and/or all field stations. Thus, the addressing of the files is utilized to determine their ultimate destination(s). In this manner, OSM 320 may be utilized in one embodiment of the invention to ensure that the client receiver of a particular field station receives only those transmissions to which it subscribes. As one example, OSM 320 ensures that North American feeds are transmitted only to North American field stations, or other stations that subscribe to the North American feeds. To prevent unauthorized access of the feeds, an encryption component may be utilized to encrypt the transmissions. Alternative embodiments may include transmitting the content encrypted to all field stations, and only providing predetermined field stations the decryption key(s).

Field stations 220 include a client receiver 350, a newsroom computer system (NCS) 312, one or more workstations 342, and/or a broadcast quality media object server (BQMOS) 360. As mentioned above, client receiver 350 is responsible for receiving transmissions from OSM 320. Messages received from OSM 320 may subsequently be forwarded by receiver 350 to NCS 312. Thus, each field station basically operates in one embodiment as a file server, web server, video receiver, and broadband IP receiver capable of pass through IP delivery as well as targeted filed delivery. Alternative configurations and/or partitioning of the functionality of NCS 312, as well as other components of the present invention are also possible in accordance with standard practice.

In this embodiment, NCS 312 may be similar to the feed station NCS 310. Alternatively, NCS 312 may include systems provided by other vendors, including for example iNews, Comprompter, etc. In accordance with the concepts of the present invention, NCS 312 builds and maintains a copy of the content list created at the feed station. Furthermore, any revisions or changes to the content list at the feed station are implemented at the field station in NCS 312.

Workstations 342, like workstations 340, may be utilized to access and/or manipulate local copies of the content lists implemented in NCS 312. As one example, the content lists may be accessed via standard Active X or web browser control. In particular, workstations 340 communicate with client receiver 350, which in turn retrieves and delivers for display on workstations 340 stories and/or any media objects referenced in the story bodies. As a result, the Active X or web browser allows users to select a live channel of video for viewing high and/or low resolution versions of recorded file objects, and command full resolution play out. Other examples of plug-ins that may be utilized to access the stories, media objects and content lists include Clip Edit, Java plug-ins, and the like. In addition to accessibility via a standard plug-in such as Active X or a web browser, the content lists may also be viewed as serial wire copy. In these cases, the content lists may be converted at NCS 312 by, for example, an Extensible Stylesheet Language (XSL) transform or the like from an Extensible Markup Language (XML) document. Similarly, the content lists may be accessed using any industry standard web browser or the like.

Broadcast quality media object server (BQMOS) 360 may be used in conjunction with the generation of a field station content list. The field station content list(s) may include stories unique to the individual field stations as well as stories received via client receiver 350 from feed station 210. Specifically, stories received from feed station 210 may be selected, via for example commands entered at workstation 342, for inclusion into a local or field station content list. The selected story, along with any item references, is copied to BQMOS 360. In order to resolve the item references, the referenced media objects are also copied to BQMOS 360 from client receiver 350. From there, the references are updated to point to and/or index objects stored in BQMOS 360. The local copies may then be further modified as desired.

In alternative embodiments of the present invention, communications from the field stations, including for example requests for media objects, may be transmitted back to feed station 210. Specifically, workstation 342 may be utilized to generate a request transmitted via client receiver 350 to feed station 210 requesting a specific media object. In these examples, a low resolution version of a media object may initially be transmitted from the feed station to a field station, with the option to, for example, purchase a high resolution version after review. If after reviewing the low resolution version a producer at the field station wishes to purchase the higher quality version, a request is transmitted via client receiver 350 to OSM 320. Subsequently, OSM 320 transmits a copy of the high resolution media object to the requesting field station.

Referring now to FIG. 3B, a block diagram representation of another example of a feed station in communication with a number of field stations is depicted. In alternative embodiments, a field station may communicate with multiple feed stations. As shown in FIG. 3B, OSM 320 and client receivers 350 are depicted with their constituent modules or components. Specifically, in the example depicted in FIG. 3B, OSM 320 includes a Media Object Server Communications Protocol receiver 321; Media Object Server Communications Protocol file parser 322; XML and object file storage 323; business rules module 324; addressing module 326; file transmit or transmission module 327; Internet File Transfer Protocol (FTP) interface 328; SkyStream (i.e., a satellite communications network) interface 329; and/or a local or remote database 325 for storing addressing information and the like.

As to the OSM components, Media Object Server Communications Protocol receiver 321 is responsible for receiving and writing, for example, Unicode XML text messages via a TCP/IP socket and saving each message as a file. Media Object Server Communications Protocol receiver 321 also handles message acknowledgment and transmission of status messages forwarded thereto.

Media Object Server Communications Protocol file parser 322 validates each XML message and parses appropriate messages for pointers (e.g., mosObj pointers) embedded in any item references. Parser 322 also fetches associated object files from MOSs 330.

XML and object file storage module 323 stores XML files and uses pointers (e.g., mosObj pointers) to retrieve referenced media objects, which are also stored by the module. More specifically, object storage may be facilitated using, for example, one or more object identifiers.

Business rules module 324 applies business rules to metadata included in the content lists, stories, and items or media objects. Generally speaking, these rules control routing of content through the system. The rules are also applied to the current status of the transmission modules and/or the level of content storage used in OSM 320 and in remote clients (e.g., receiver clients 350).

The metadata, on the other hand, describe the service the content is intended for and potentially any clients that may be embargoed from receiving the information. Metadata may also be used for other purposes, such as describing intellectual property rights, rights information, output time, output channel, and the like. In some embodiments, the metadata may include text, XML markup, binary information, and the like. The metadata is used in conjunction with, for example, the addressing module to selectively address and transmit content lists, stories, and/or media objects to the clients. For instance, the metadata are typically embedded as tags within the story bodies. OSM 320 uses these tags to determine where to deliver the information. In some embodiments, the metadata may be used for other purposes, including, for example, to describe intellectual property rights or to exclude delivery to certain field stations (i.e., embargoing a client). Examples of metadata tags include tags from any standard metadata libraries such as the standard SMPTE or SMEF libraries or the like. In addition, specialized tags may also be developed.

Addressing module 326 receives plain language feed and client names and resolves them to delivery destinations which may be identified in any standard industry manner including IP addresses, multicast addresses, file folder destinations, and the like.

File transmit module 327 utilizes addressing information to deliver XML and object files to appropriate storage locations. File transmit module 327 also ensures that the files are delivered in appropriate formats according to the chosen or predetermined delivery mechanism(s) for delivery to client destinations. Specifically, file transmit module 327 compares the metadata with data from a database (e.g., database 325) that stores the relationships between metadata descriptors and information from, for example, a standard conditional access system. The conditional access system is responsible for managing transactions and ensuring that only subscribers who are authorized to receive a service can get access to it. After comparison, the OSM derives the appropriate conditional access descriptors, which are then passed to the conditional access system. The conditional access system then addresses the information and facilitates transmission.

Internet FTP and SkyStream interfaces 328 and 329 utilize control information received from the file transmit module to determine the particular files to be sent to clients (e.g., client receivers 350) via, for example, the Internet and/or a satellite transmission path. In addition, other control information may be sent from the file transmit module to the interfaces for controlling the level of forward error correction, the frequency of repetition, and/or priority of files in the queue. In some embodiments, Internet FTP and/or SkyStream interfaces 328 and 329 are capable of passing information upstream back to OSM 320. For example, health and status information and information facilitating development of an e-commerce model (as will be described below), and the like may be transmitted upstream to OSM 320. Internet and/or SkyStream interfaces 328 and 329 may also transmit multiple files simultaneously to individual clients in addition to supporting simultaneous transmission to multiple clients. Furthermore, any number of channels may be supported by Internet or SkyStream interfaces 328 and 329 including: standard Media Object Server Communications Protocol messages such as roConstruction messages, roStorySend messages, and/or control messages, as well as low resolution objects or proxies, and/or high resolution content, etc.

Client receivers 350 include: an Internet FTP or SkyStream interface 351a and 351b; backchannel module 352; file receive module 353; Media Object Server Communications Protocol file parser 354; XML and object file storage 355; business rules module 356; ASP web server 357; and Media Object Server Communications Protocol output, serial output, and/or video output modules/components 358, 359, 360.

Several of the client receiver components are similar to and interact with corresponding OSM components. Specifically, the client receiver Internet FTP and SkyStream interfaces 351a and 351b work as clients with the corresponding OSM interfaces to receive communications therefrom. The file receive module 353 receives files from SkyStream and/or Internet FTP interfaces 351a and 351b, registers the files, and stores them to disk. The client receiver Media Object Server Communications Protocol file parser 354, XML and object file storage module 355, and business rules module 356 are all similar to their OSM counterparts. In addition, business rules module 356 may include functionality for purging media objects no longer referenced in stories or content lists, holding embargoed content, compiling usage statistics, and/or transmitting statistics and health and status transmission interfaces.

As shown in FIG. 3B, ASP web server 357 acts as a graphical user interface, which may be displayed on, for example, workstations 340 or 342. Typically speaking, the pages displayed by ASP web server 357 are similar to those provided by ActiveX and include a list of content lists or running orders; a list of stories in a selected content list; the text of a selected story; a list of media objects in a selected story; and/or a proxy version of a selected media object. Thus, ASP web server 357 provides the above-mentioned web interface. The interface facilitates user manipulation of the objects and user searches using text, metadata and/or other data contained in the media object pointers as search terms. The interface also optionally allows remote control play out of video from the server from, for example, a web browser user interface, e-commerce transactions (as will be discussed below), and may be remotely updated via the same transmission mechanisms that are used to transmit XML and object files. In addition, the interface facilitates streaming of the low resolution proxy files and includes an FTP interface, which exposes XML and object files for other devices to retrieve.

Video output module 360 plays out the full resolution version of requested objects, typically, in response to a command received from, for example, ASP web server 357 or interface. In some embodiments, video output module 360 may output a low resolution proxy if the requested full resolution version does not exist. Furthermore, module 360 is able to queue any number of requests and may add title or other information extracted from the story and object metadata into the output. Optionally, module 360 may also cue any legacy tape machines to record and stop.

Media Object Server Communications Protocol output module 358, optionally, forwards Media Object Server Communications Protocol messages as appropriate and as they conform to any business rules to local NCSs. From there, the messages may be used to recreate the content lists, stories, and/or references to media objects. Serial or serial wire output module 359 reformats XML story information via, for example, XSL transforms, into any number of different agency wire transmission formats. These text files may then be transmitted via a serial interface at a configurable speed.

MOSs 330, which constitute video and/or other media servers (e.g., audio, still store, web object, live feed, etc.) include, for example, a video clip input module 331, a high resolution (e.g., 8 mbps) file encoder 332, a low resolution (e.g., Windows media) file encoder 333, an object file storage 334, and Media Object Server Communications Protocol transmitter 335. Video clip input module 331 controls the input of metadata and the recording and playback of a media clip. As discussed above, embodiments of the invention contemplate that two versions of the media object may be encoded. An example of the high resolution version includes a version recorded at 8 mpbs. The lower resolution version is intended generally for browse and proxy use, and is therefore encoded at a relatively lower bit rate and spatial resolution. Object file storage unit 334 references the media clips using any suitable means, including for example a media identifier. Object file storage unit 334 facilitates both HTTP and FTP interfaces, and optionally other standard interfaces. In addition, other applications may utilize, for example, the mosObj pointer to resolve an HTTP path to the low resolution objects for browsing. Furthermore, OSM 320 and other devices may be able to use information in mosObj messages and the like to generate an FTP path to the low resolution objects. Media Object Server Communications Protocol transmitter 335 transmits, for example, standard MOS messages including mosObj messages to NCS 310, utilizable for both high resolution as well as low resolution objects.

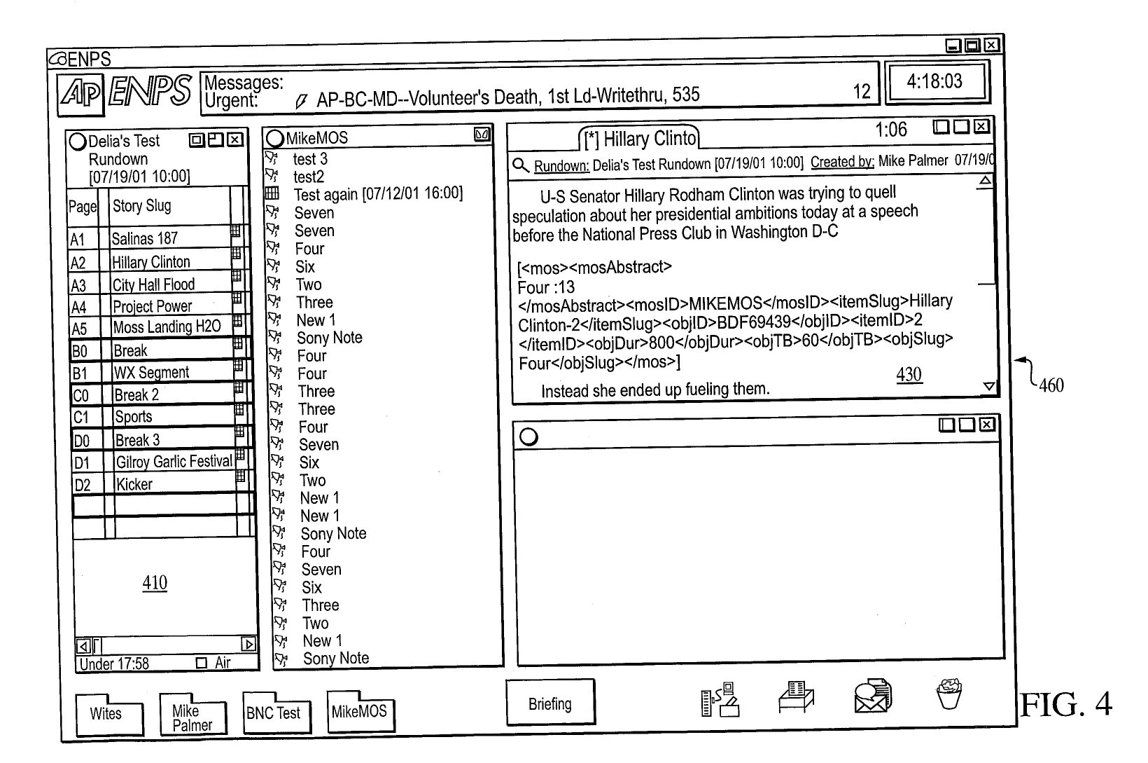

FIG. 4 depicts one example of a graphical user interface (GUI) 400 displayed on, for example, workstations 340 or 342. In this example, GUI 400 includes a list of content lists, a list of stories in a selected content list, the text of a selected story, and/or a list of media objects in a selected story. In particular, a content list 410 includes an ordered listing of any number of stories. In the example shown in FIG. 4, content list 410 includes a story relating to Hillary Clinton at 420. The actual script and/or text constituting story 420 may be accessed (i.e., created, read and modified) at display 430. As will be discussed below, in addition to text, the story body may also optionally include metadata, and/or item references (e.g., references to media objects).

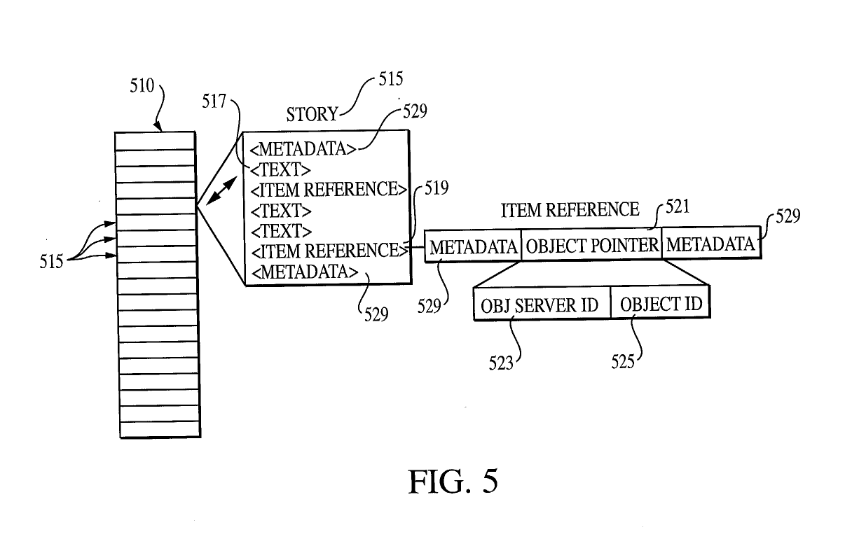

Referring to FIG. 5, a block diagram representation of an example of a content list 510 and its component parts is depicted. As mentioned above, content list 510 is comprised of a listing, optionally ordered, of a number of stories 515. In addition, each story is comprised of any or all of text 517, metadata 529, item references 519, and/or other similar components. Thus, a story may be comprised of only text elements. Similarly, a story may include only text elements or item references. A story can also be composed of metadata only, text only, or item references only, or any combination of these elements. Any single or combination of the above mentioned components are possible. In this example, each item reference includes an object pointer 521, which points to a particular media object stored in for example MOS 330. Specifically, object pointer 521 may include an object server identification 523, for identifying the server in which the object is stored, and an object identification for identifying the object within the server. As discussed above, the item references are placed within the stories by the story authors or automatically by the authoring system, and indicate when and where the media object is to appear. Furthermore, each story may also include metadata 529. Generally speaking, the metadata describe how the content is to be played. Similarly, (as mentioned above) the metadata may include a service description designating the field stations that are to receive or not receive the news stories. Furthermore, the metadata may also be used to describe intellectual property rights management data and the like. In addition to the above, each story may also contain other information including, for example, a description/summary, abstract, etc.

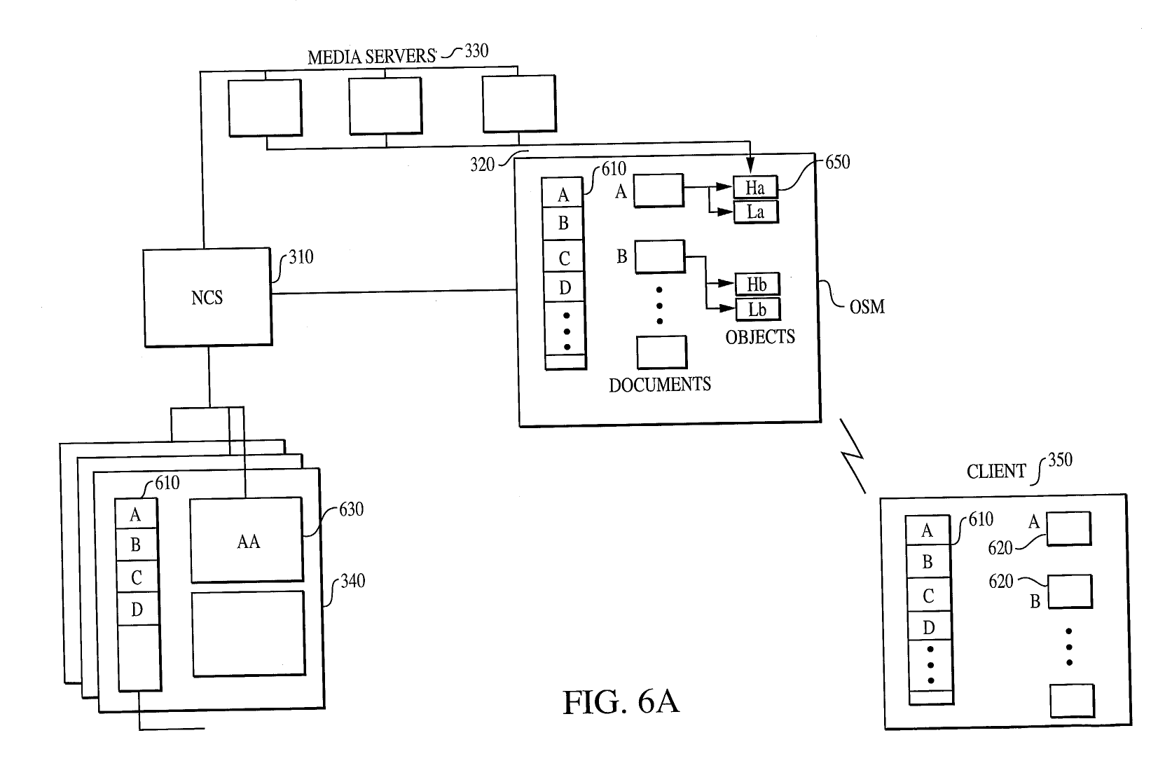

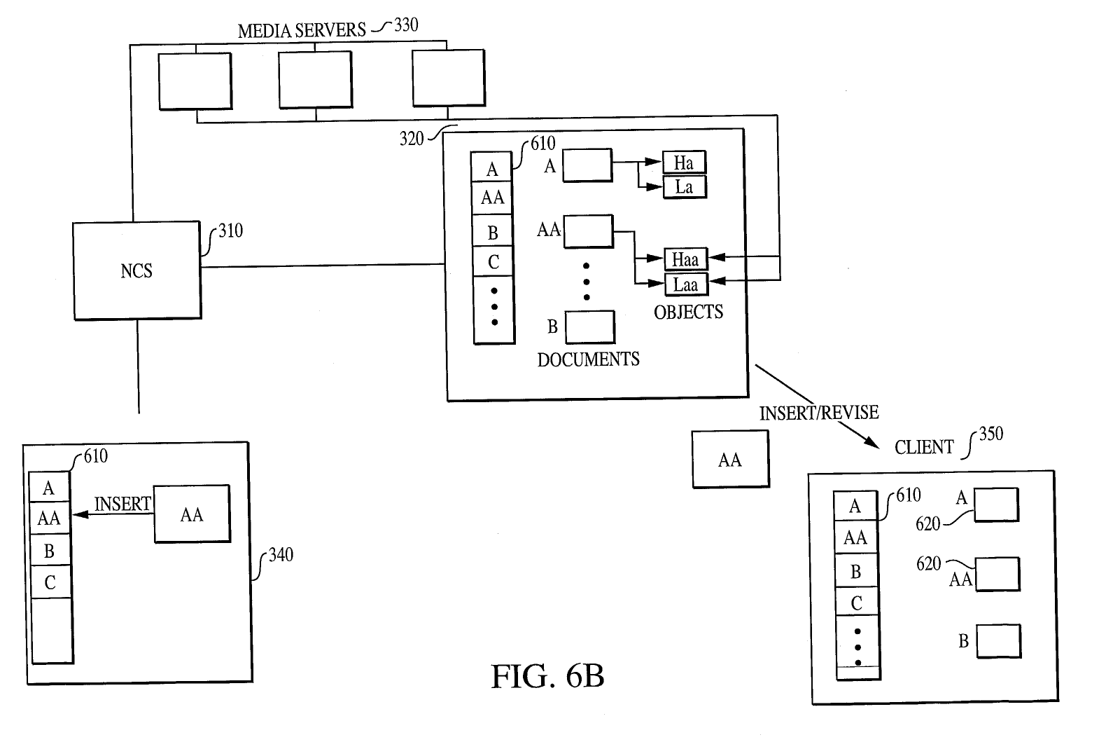

FIGS. 6A and 6B depict combined system and process diagrams illustrating an updating and/or revising procedure of the present invention. Referring first to FIG. 6A, a content list 610 is shown as being displayed on workstation 340. As discussed above, identical copies of content list 610 are displayed at a feed station workstation 340 and implemented at the field station client receiver 350. Thus, each of the stories 620 listed in content list 610 (e.g., stories a, b, c, and d) are displayed at workstation 340 and client receiver 350. Also, items or media objects referenced by the stories 650 are stored in MOSs 330, and retrieved or encoded in any number of versions before being transmitted to a client receiver 350. In the example shown in FIGS. 6A and 6B, high resolution (e.g., Ha and Hb) and low resolution (e.g., La and Lb) versions of media objects are associated with each referenced object. Thus, before transmitting a story to client receiver 350, both high and low resolution media objects are retrieved from MOSs 330 and packaged into messages or files by OSM 320.

Thus these messages may include any single or combination of text elements, metadata, references to media objects, and/or media objects. Similarly, the messages may include data pertaining to the sequence of stories in a content list. Furthermore, in some embodiments, the messages may be timestamped or otherwise identified to allow for the re-requesting of missing messages. Also, the messages may be compressed before transmission.

In the present invention, workstation 340 may be utilized by a writer or producer to create or write an original news story. Similarly, workstation 340 may be utilized to modify or revise (or delete) existing stories. Thus, new text may be added to incomplete and/or developing stories. In a similar manner, new media objects may be referenced as they are recorded or otherwise generated, and added into the stories. In addition, the order of the stories in content list 610 may be revised. Advantageously, these additions, revisions or deletions, are optionally implemented substantially instantaneously at a content list stored at feed station client receiver 350. Furthermore, the additions, revisions or deletions are optionally implemented at the feed station client receiver content list without requiring the transmission of the entire content list. Instead, only the revised data or information, as packaged in a message, is transmitted.

In the example depicted in FIG. 6A, an original news story aa is generated at display 630 of workstation 340. As shown in FIG. 6B, story aa may be inserted or placed into content list 610 at any location. In FIG. 6B, story aa is inserted into content list 610 after story a and before story b. Revisions such as the addition of story aa at workstation 340 are implemented directly onto OSM 320. Subsequently, story aa, and any other additions and/or changes to content list 610, the stories listed therein, or to any media objects, may be transferred to client receiver 350. Specifically, each of the items or objects referenced in story aa are retrieved from MOSs 330, and packaged into messages or files, along with the content list revisions, for transmission to client receiver 350. After transmission, a copy of story aa, and copies of the items referenced by the story, appear in client receiver 350. In this manner, the additions and/or revisions made at a feed station may be implemented at the field station end without the transmission of an entire content list.

An example of the present invention in operation utilizing the standard Media Object Server Communications Protocol is now discussed. Generally speaking, Media Object Server Communications Protocol allows Newsroom Computer Systems (NCS) and Media Object Servers (MOS) to exchange information using a standard protocol (language and vocabulary). This protocol enables the exchange of the following types of messages: descriptive data for media objects; content list (or playlist) exchange; and/or status exchange. With descriptive data, MOSs 330 push descriptive information and pointers to NCS 310 as objects are created, modified, or deleted in the MOSs 330. This allows NCS 310 to be aware of the contents of MOSs 330 and enables NCS 310 to perform searches on and manipulate the data sent by MOSs 330. With content list exchange, NCS 310 builds and transfers content list information to MOSs 330. This allows the NCS to control the sequence that media objects are played or presented. With status exchange, MOSs 330 can inform NCS 310 of the status of specific clips or the MOS system in general. Likewise NCS 310 can notify MOSs 330 of the status of specific content list items or running orders. Furthermore, although the Media Object Server Communications Protocol is utilized in this example, it is to be understood that any other similar or analogous protocol may also be used. Initially, a producer or writer enters the text of a story body using a workstation 340 of NCS 310. In this regard, the producer or writer may include any number of item references into the story body pointing to a video or other media object related to the story. Subsequently, the story body may be inserted into a content list where it may be reviewed and/or approved for distribution by, for example, an editor.

As discussed above, OSM 320 receives a number of categories of information from NCS 310. The first is the order of the stories in the content list. The second is a collection of all of the stories stored as, for example, XML documents. These documents contain the descriptive text of the story, any embedded pointers, and/or any metadata.

Upon receipt, OSM 320 examines the story body XML documents and extracts any pointers. The pointers (via identifiers) are resolved to the file name of the object for FTP transfer. In this example, OSM 320 then performs an FTP fetch of a full resolution object file from a predefined fixed path for the full resolution object. Alternatively, OSM 320 may also be used in conjunction with a standard video encoder or the like to render the object as a file. OSM 320 also performs a second FTP fetch of a low resolution object using the same file name but from a different fixed path.

After fetching the objects, OSM 320 combines the high resolution object, low resolution object, and story body into, optionally, a single file for delivery. Thus, if no media objects exist, the text file is packaged alone. If only a low resolution media object exists, then the text file and the low resolution object are packaged together. Other combinations of data using other standard transfer protocols may alternatively be used. For example, there is no requirement that low resolution objects be transmitted at all.

After the filed is packaged, OSM 320 sends the package to an internal transmission module along with metadata extracted from the text file related specifically to the delivery mechanism being used. Examples of such metadata include service description information, specific exceptions to the standard description (e.g., feed points in addition to and/or embargoed members of the standard service description), and/or transmission priority.

The package is then placed in a queue where it is optionally (see below) sequenced according to the priority described in the metadata. Any number of queues may be utilized. For example, queues may exist for control messages, low resolution objects, and/or high resolution objects and the like. As to these particular queues, control messages may be sent out in sequence. In contrast, low and high resolution queues may be managed by priority first and then by age (e.g., FIFO). Among the queues, control messages may have the highest priority, followed by low resolution, and then high resolution objects. One or more messages from each queue can be transmitted simultaneously with messages from other queues. The transmission module of OSM 320 compares the metadata descriptors with the data from an addressing database and derives the appropriate conditional access descriptors, which are then passed to a conditional access system. The conditional access system then addresses and, optionally, encrypts the package such that only authorized destinations can receive the package.

At the field station end, a client receiver receives the transmitted packages and, optionally, decrypts and extracts IP data simultaneously with reconstruction of any live video channels (e.g., MPEG2 DVB). In this example, the receiver may be capable of receiving multiple package transmissions and writing them to disk at a rate of, for example, 16 Mbps.

As to error correction, any standard industry method may also be used. For example, “Carousel” or delayed retransmission processes may be implemented, which attempt to retransmit all objects at certain time intervals. Similarly, upon detecting an error in a packet of a package, the client receiver may utilize a standard TCP/IP backchannel to contact OSM 320 to request retransmission of the bad packets. As yet another example, if OSM 320 receives a large number of retransmission requests, it may automatically retransmit the entire package. Large packages may also be automatically encoded by OSM 320 with the standard KenCast or SkyStream (or similar) forward error correction. If a KenCast or SkyStream encoded object fails to be received by the client receiver without error, the field station waits until the window for the first retransmission has expired before it requests retransmission of the entire package.

After receiving the package, the client receiver disassembles it into constituent elements. Thus, high and low resolution versions of objects are stored on a local hard disk. The text portions may also be stored in a similar manner. In this example, the text files received by the client receiver are processed using, for example, an XSL transform and style sheet in a manner that renders the story in wire/agency format. This information may then be sent to a local NCS as serial data.

With objects included in the packages, a mosObj message is also created and (if enabled on the receiver) transmitted to the NCS and any other defined targets. In this example, the message includes the text story in the mosExternalMetadata and mosDescription messages. In this and other examples, the client receivers may be arranged to acknowledge all incoming messages. Field station users may access the information via, for example, ActiveX control (run within either the NCS or Internet Explorer). Thus, in addition to standard ENPS procedures, the user may move, size, and close any displays.

Advantageously, when a feed producer (at, for example, feed station 210) removes an item from a content list, commands are transmitted to the client receivers so that the corresponding content (e.g., story bodies, content lists, and/or media objects) is deleted or revised. In a related manner, media objects, story bodies, and/or content lists may be automatically purged from the client receiver before or according to a different schedule than the related content.

Furthermore, OSM 320 checks item references in each story to determine whether an object has been transmitted as part of another content list. If it has, the object is not transmitted again. Likewise, if the object is updated, it is not transmitted twice as part of two separate content lists. Thus, media objects are transmitted when they are modified, not when they are included or moved in multiple other content lists.

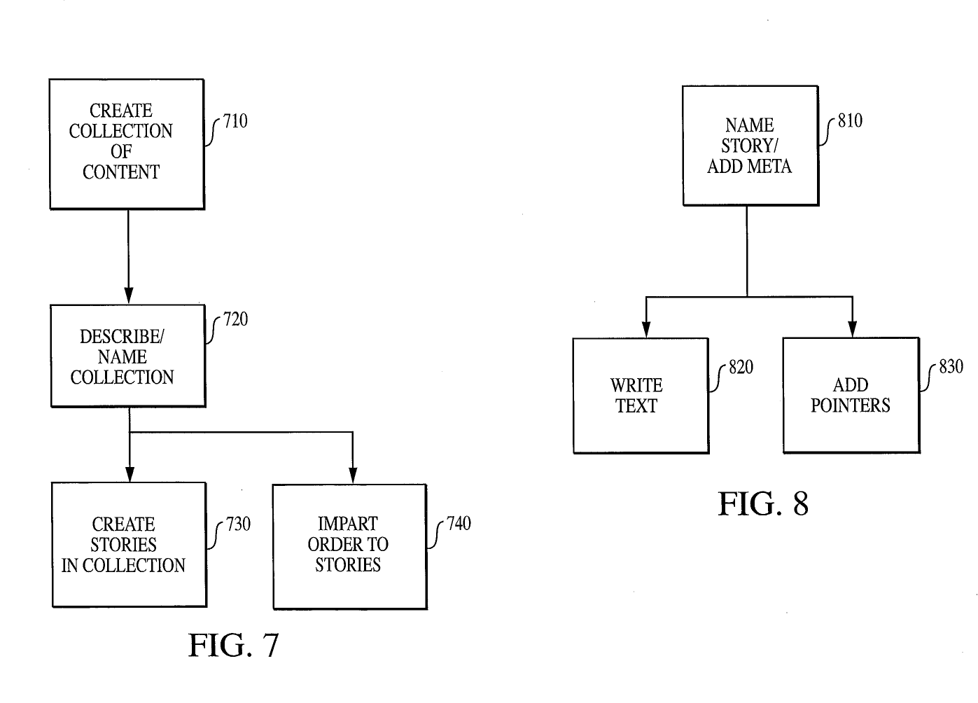

FIG. 7 illustrates one example of a process utilizable for creating a news story or other content. Initially, using, for example, a workstation 340 of NCS 310, an author may create a collection of content (STEP 710). For instance, an editor may create a content list associated with the news events of a particular day. In a newsroom setting, the content list may include any number of stories with each story containing any number of references to media objects. Subsequently, the collection or list is described or named (STEP 720). After the collection has been named, the individual stories or pieces of content may be created or written (STEP 730). For example, an author may write the text constituting the story, and include any number of media objects by adding an item reference to the story body. In addition, an author or editor may also impart an order to the stories within the content list (STEP 740).

FIG. 8 illustrates one example of a process utilizable for creating a story. More particularly, an author begins by naming or identifying the story and adding metadata (STEP 810). Then, the stories may be written utilizing workstations 340 of NCS 310 (STEP 820). In addition, as mentioned above, item references may be added to the stories for referencing any number of media objects (STEP 830).

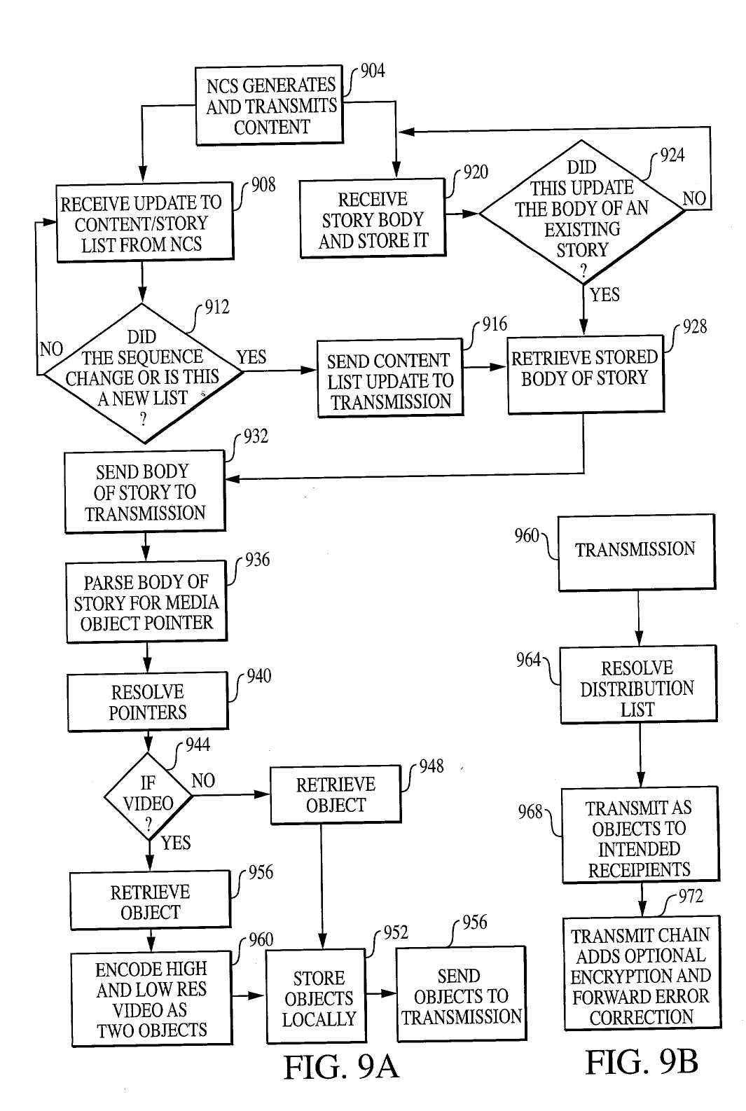

FIG. 9A illustrates one example of a process utilizable for implementing additions and/or revisions to content lists, story bodies, or media objects for transmission to, for example, field stations 220. Initially, utilizing for example the processes described in FIGS. 7 and 8, new content (e.g., stories and the like) and/or updates to the order of a content list are generated and forwarded from NCS 310 to OSM 320 (STEP 904). Then, OSM 320 receives the updates (STEP 908) and determines whether the sequence or order of the list has been revised or whether the list is a new (i.e., newly created) content list (STEP 912). If the order has been altered or if the list is new, OSM 320 sends the content list update for transmission (STEP 916).

Story bodies are treated in a similar manner. For instance, a story body transmitted from NCS 310 is received by OSM 320 and stored (STEP 920). Subsequently, OSM 320 determines whether the story body is an update or a revision to an existing story (STEP 924).

After OSM 320 determines that an update or a revision has occurred or that a new piece of content has been added, OSM 320 retrieves the stored body of the story (STEP 928). Upon retrieving the stored story body, OSM 320 sends the body of the story for transmission (STEP 932). Subsequently, OSM 320 parses the body of the story for any item references (STEP 936). Each item reference located by OSM 320 is then resolved (STEP 940). Specifically, OSM 320 first determines whether the item referenced is a video object (STEP 944). If the referenced object is not a video object (e.g., audio), the object is retrieved from, for example, MOSs 330 (STEP 948) and stored locally (STEP 952). On the other hand, if the referenced object is a video object, the object is also retrieved from, for example, MOSs 330 (STEP 956). The retrieved object is then encoded into high and low resolution versions as two video objects (STEP 960). Like other objects, these high and low resolution objects are also stored locally (STEP 952). Each of the stored objects is subsequently sent for transmission (STEP 956).

Referring to FIG. 9B, one example of a transmission process utilizable for transmitting new and updated story bodies, content lists and/or media objects is now depicted. Initially, the information (e.g., the new and updated story bodies, content lists and/or media objects) is sent by OSM 320 for transmission (STEP 960). Upon being sent to transmission, the distribution list is resolved (STEP 964). In particular, the distribution list identifies, using the metadata in the content, each of the intended recipients of a story, content list or media object. In this manner, recipients of the North America feed may be prevented from receiving African feed information. After resolving the distribution lists, the information may be transmitted to the intended recipient (STEP 968). For example, the information may be transmitted via the Internet 230 or any of communications networks 240 or 250 using any industry standard communication protocol. Finally, any optional encryption procedures or optional forward error correction codes may be applied to the information to be transmitted (STEP 972).

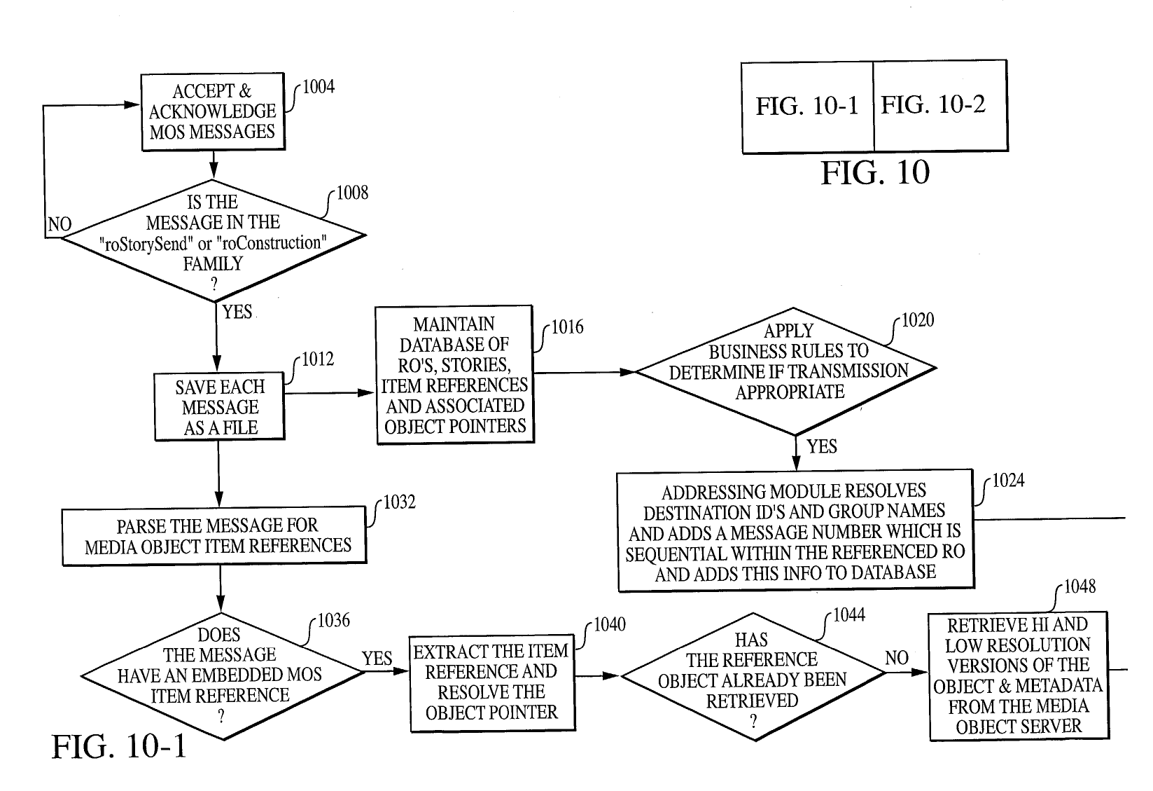

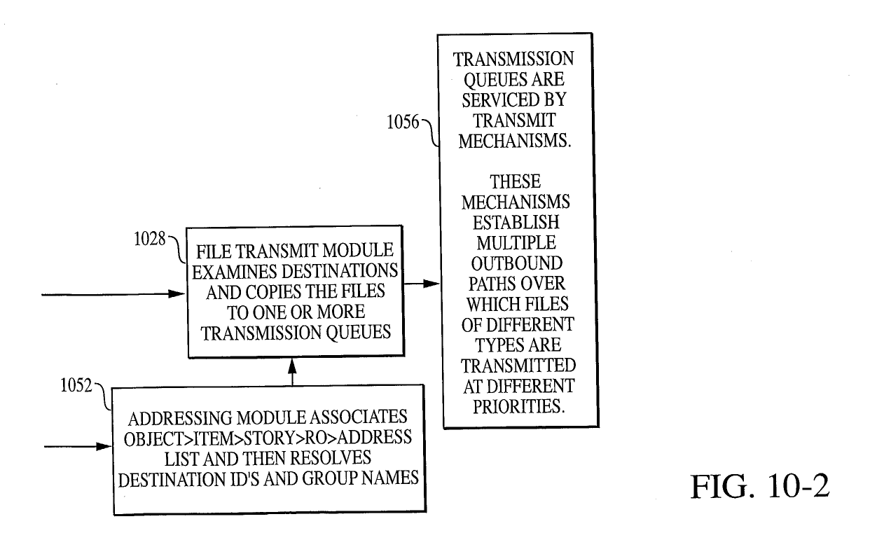

In accordance with the principles of the present invention, FIG. 10 illustrates one example of a process utilizable by OSM 320 for transmitting content and/or information (e.g., new and updated story bodies, content lists and/or media objects). In the example of FIG. 10, Media Object Server Communications Protocol is utilized to facilitate processing. However, it should be noted that even though the Media Object Server Communications Protocol is described as being utilized in this example other similar and analogous protocols are just as easily implementable.

To commence the process, OSM 320 accepts and acknowledges messages received from, for example, NCS 310 (STEP 1004). Each of the messages received is checked by OSM 320 to determine whether they require changes or updates to be transmitted to, for example, field stations 220 (STEP 1008). As an example, such messages may include messages from the Media Object Server Communications Protocol roStorySend or roConstruction family. Each message requiring changes or updates to be transmitted is saved as a file by OSM 320 (STEP 1012) and maintained in a local database. Thus, any or all of the content lists, stories, item references, and/or associated object pointers may be maintained by OSM 320 (STEP 1016).

For each content list, story or other piece of information to be transmitted, the business rule module of OSM 320 applies a set of business rules to determine if transmission is appropriate (STEP 1020). For example, after reviewing story metadata indicating that transmission is not to occur until later in the day, OSM 320 may delay transmission until that later time. If transmission is appropriate, the addressing module of OSM 320 resolves destination identifiers and group names identified by the content and adds a message number that is sequential within the referenced content list, which is then added to the local database (STEP 1024).

After saving each message as a file (STEP 1012), OSM 320 parses the messages for any item references or references to media objects (STEP 1032). In particular, OSM 320 determines whether each message has an embedded Media Object Server Communications Protocol item reference (STEP 1036). If so, the item reference is extracted and the object pointer is resolved (STEP 1040). If not, processing returns to the step of examining new messages (STEP 1004).

Once the object pointer has been resolved (STEP 1040), OSM 320 determines whether the referenced object has already been retrieved (STEP 1044). If so, processing returns to the step of examining new messages (STEP 1004). If not, high and low resolution versions of the object and metadata are retrieved from MOSs 330 (STEP 1048). Then, the addressing module of OSM 320 associates the objects and metadata with the corresponding story and/or content list, and resolves the destination identifiers and group names associated with the content (STEP 1052).

Subsequently, the file transmit module of OSM 320 examines the destinations of the content and copies the files to one or more transmission queues (STEP 1028). These transmission queues are serviced by a number of transmit mechanisms, which in turn establish multiple outbound paths. For example, the different queues may correspond to different tiers of delivery speeds. Thus, information may be delivered at different speeds depending on the information's priority. The files are then transmitted over these paths according to file type at differing priorities (STEP 1056).

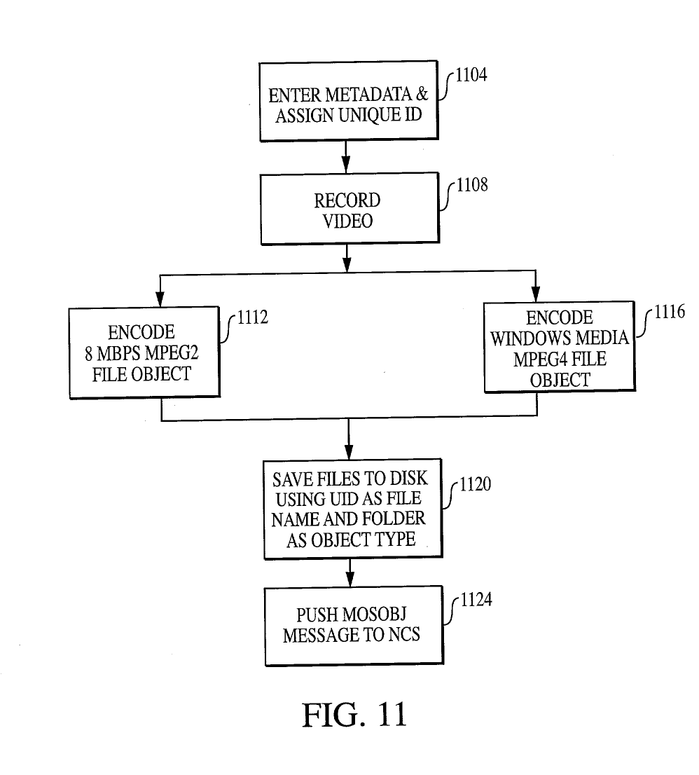

In accordance with the principles of the present invention, FIG. 11 illustrates one example of a process utilizable for processing media objects before transmission to field stations 220. Initially, MOS 330 enters metadata and assigns a unique identifier to a video or other media clip to be inputted (STEP 1106). Subsequently, the media clip is recorded and inputted into MOS 330 (STEP 1108). The inputted media clip may then be encoded in any number of versions (STEPS 1112 and 1116). In the example depicted in FIG. 11, the media clip is encoded into a MPEG2 file object and a Windows Media MPEG4 file object. Each of these encoded files is saved to disk, and may be identified according to their unique identifiers and/or folder parameters (STEP 1120). Once the files have been saved, the Media Object Server Communications Protocol Obj message is pushed to NCS 310 to indicate completion of processing (STEP 1124).

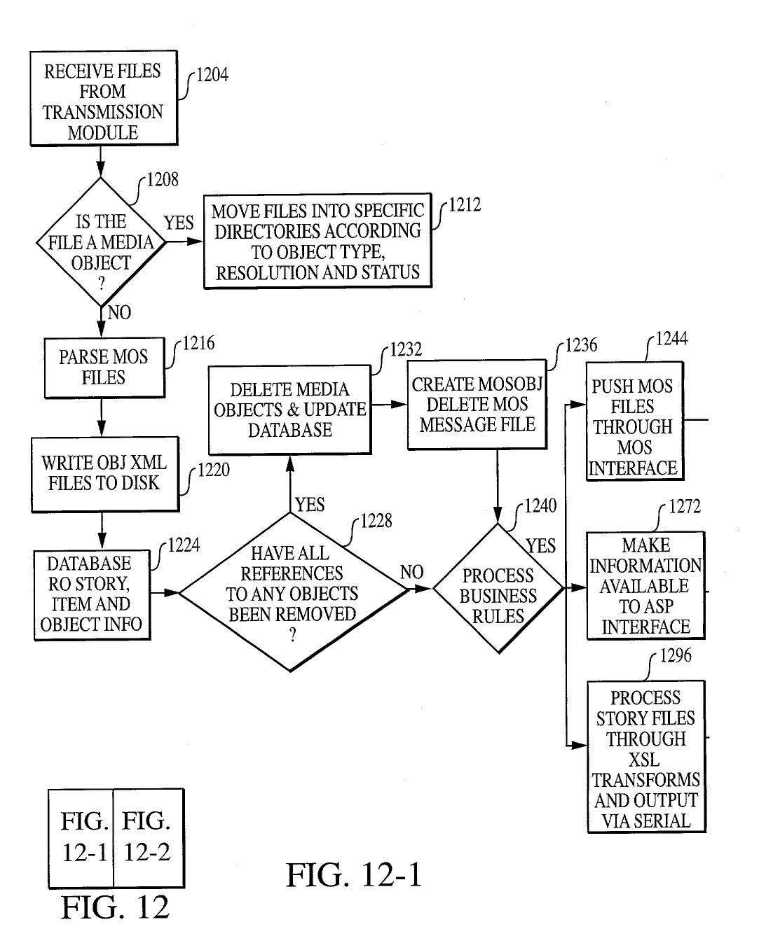

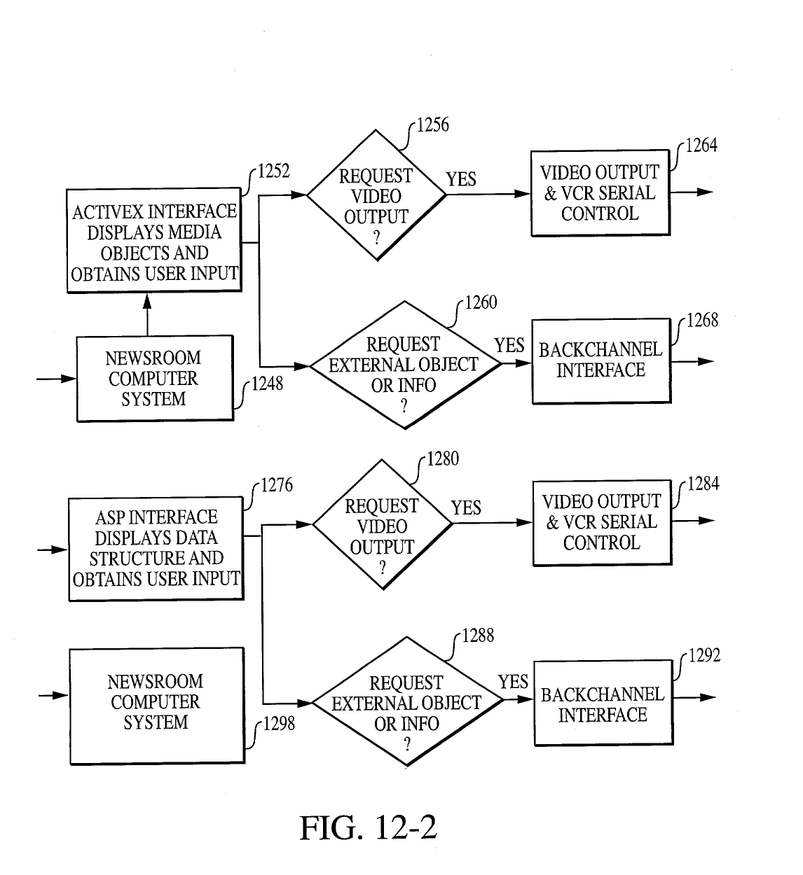

Referring to FIG. 12, one example of a process performed by client receiver 350 upon receiving a file is depicted. First, a file is received by client receiver 350 from the transmission module of OSM 320 (STEP 1204). These files are examined by client receiver 350 to determine whether the files are media objects or story bodies messages (STEP 1208). If the files are media objects, the files are moved onto hard disk or the like (STEP 1212). For example, in some embodiments, the files may be stored in specific directories according to object type, resolution, status, and the like. If the files are not media objects, client receiver 350 parses the Media Object Server Communications Protocol files (STEP 1216) and writes any XML files to disk (STEP 1220) according to the object's content list, story identifier, and other information (STEP 1224). Subsequently, client receiver 350 determines whether all references to any media objects have been removed (e.g., because the objects have been replaced with new objects, etc.) (STEP 1228). If so, the media objects are deleted and the database is updated (STEP 1232). Furthermore, in this embodiment, a deleted message file may optionally be created (STEP 1236). Once steps 1232 and 1236 have been performed or if all references to media objects have previously been removed, a business rules module of client receiver 350 processes the business rules (STEP 1240).

As shown in FIG. 12, the present invention is compatible with client receivers operating in any number of modes. For example, with client receivers that are fully compatible with OSM 320, the received files are initially pushed through a client receiver interface (STEP 1244) and a field station newsroom computer system (STEP 1248) to allow access to the field station users. In these cases, an ActiveX interface displays the media objects to the user and allows the user to enter any inputs or commands (STEP 1252). For example, if the user requests video output (STEP 1256), a video output module outputs the requested object (STEP 1264). Similarly, if the user requests an external object or information (STEP 1260), a message is transmitted to OSM 320 using a backchannel interface or the like (STEP 1268).

With client receivers that utilize web browsers, the transmitted information is made available via, for example, an Active Server Page (ASP) interface (STEP 1272). In these situations, the ASP interface displays the data structure and obtains any user input (STEP 1276). Like with the fully compatible client receiver examples, if the user requests video output (STEP 1280), a video output module outputs the requested object (STEP 1284). Similarly, if the user requests an external object or information (STEP 1288), a message is transmitted to OSM 320 using a backchannel interface or the like (STEP 1292). With older generation client receivers, the received stories are processed through, for example, an XSL transform (STEP 1296) before being output as serial wire copy on a newsroom computer system interface (STEP 1298).

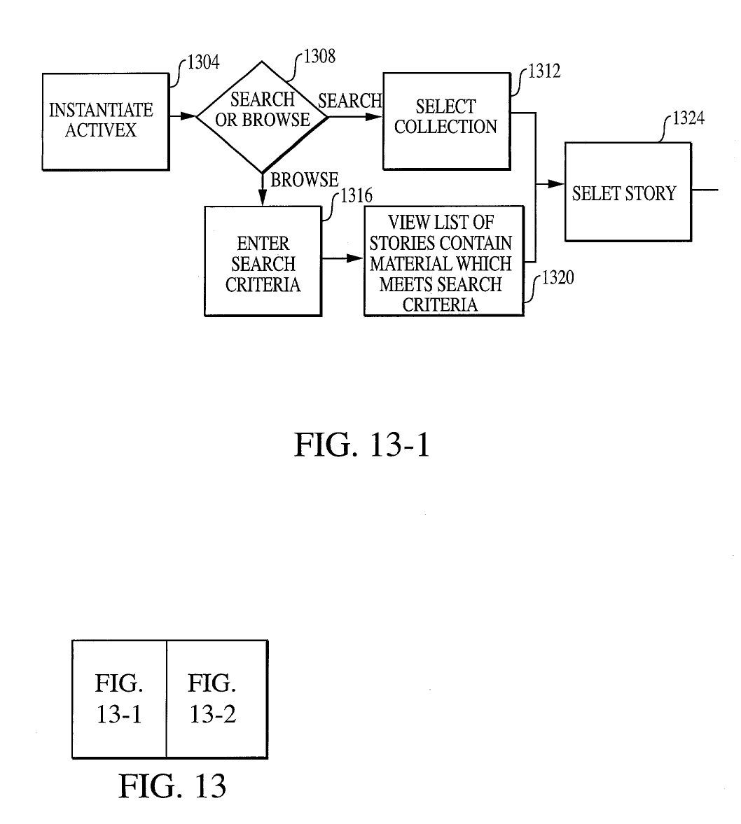

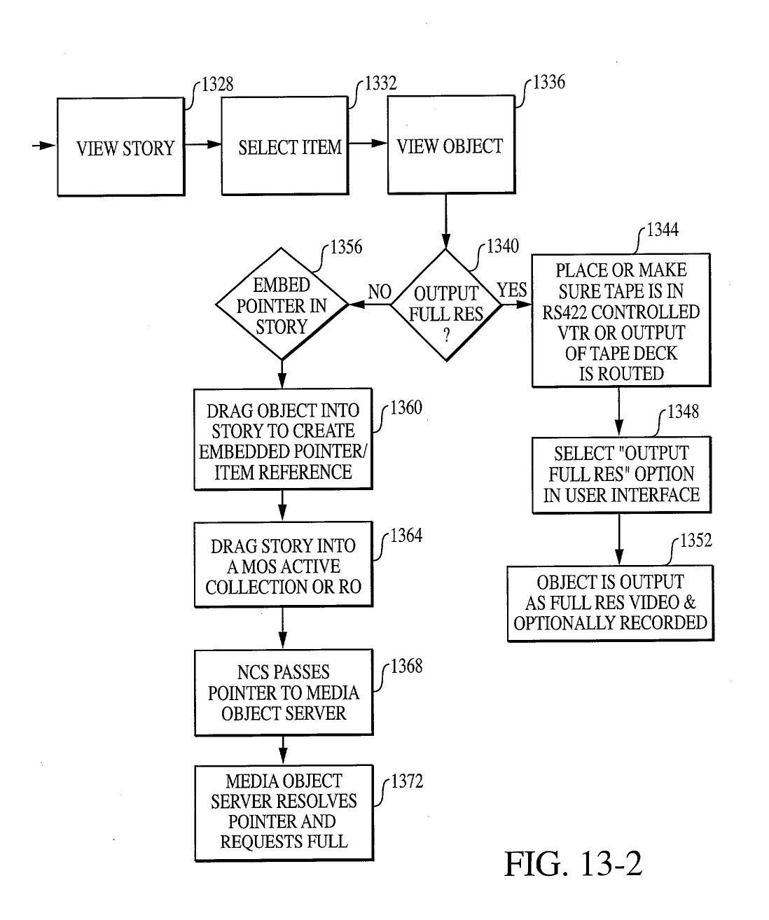

Referring to FIG. 13, one example of a process utilizable by an ActiveX or other plug-in running on, for example, workstation 342 is described. First, an ActiveX instance is instantiated by a user at, for example, workstation 342 (STEP 1304). Upon instantiation, the user may choose to search or browse for content (STEP 1308). If the user wishes to search, a particular collection or content list is selected and displayed (STEP 1312). If the user wishes to browse, search criteria may be entered (STEP 1316). Using these search criteria, a list of stories containing material that meets with the search criteria is displayed (STEP 1320).

From the list of stories displayed, the user selects (STEP 1324) a particular story for viewing (STEP 1328). Upon viewing the selected story, the user may select and view an item or media object referenced by the selected story (STEPS 1332 and 1336). In particular, once an item has been selected for viewing, client receiver 350 determines whether a full resolution version is available (STEP 1340). If a full resolution version is available, the user is prompted to place or confirm that a video tape or the like is placed in a player (STEP 1344). Then, in response to the selection of outputting a full resolution version from, for example, interface 400 (STEP 1348), the selected object is output or displayed as full resolution video and/or optionally recorded (STEP 1352). If, on the other hand, the full resolution version is not available, an embedded pointer in the story is examined (STEP 1356). From there, an object is dragged into the story to create an embedded pointer or item reference (STEP 1360), after which the story is dragged into an active content list (STEP 1364). Subsequently, the NCS passes the pointer to the MOS (STEP 1368), which in turn resolves the pointer and requests a full resolution version of the object (STEP 1372).

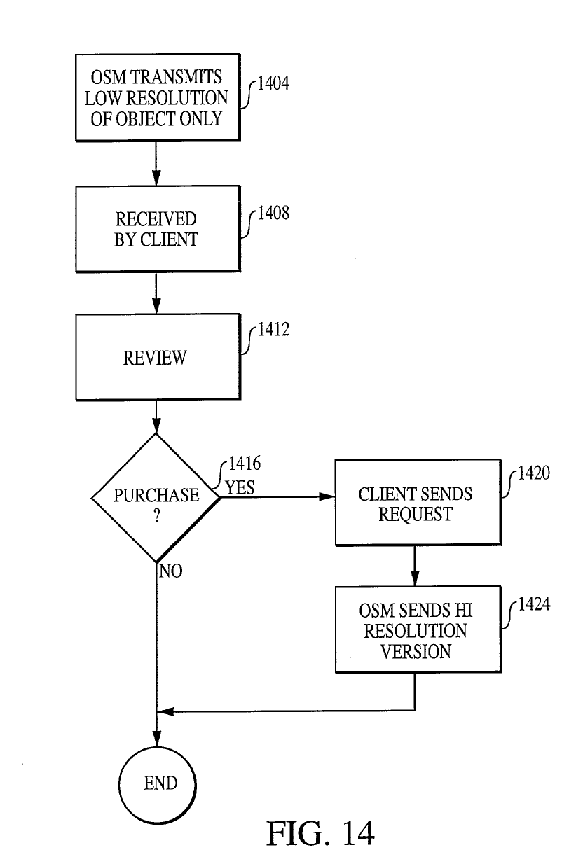

One example of an e-commerce process utilizable for purchasing media objects is now described with reference to FIG. 14. In general, the e-commerce model utilizes an optional and/or alternate data communication network to enable interactive purchase and delivery of information. Specifically, OSM 320 commences the process by transmitting only a low resolution version of an object (STEP 1404). After transmission from OSM 320, the low resolution version of the object is received by, for example, client receiver 350 at field station 220 (STEP 1408). Using, for example, interface 400, a user may review the low resolution of the object (STEP 1412). Subsequently, client receiver 350 determines whether the user wishes to purchase a high resolution version (STEP 1416). If so, client receiver 350 transmits a request to OSM 320 (STEP 1420), in response to which OSM 320 transmits the requested high resolution version of the object. In addition, billing information may also be obtained and recorded at, for example, OSM 320 and used to bill the customers at a later time. In a similar manner, users may browse low resolution versions of media objects from an archive, before making a decision to purchase an object. Purchased objects may then be delivered via OSM 320 over the communication network.

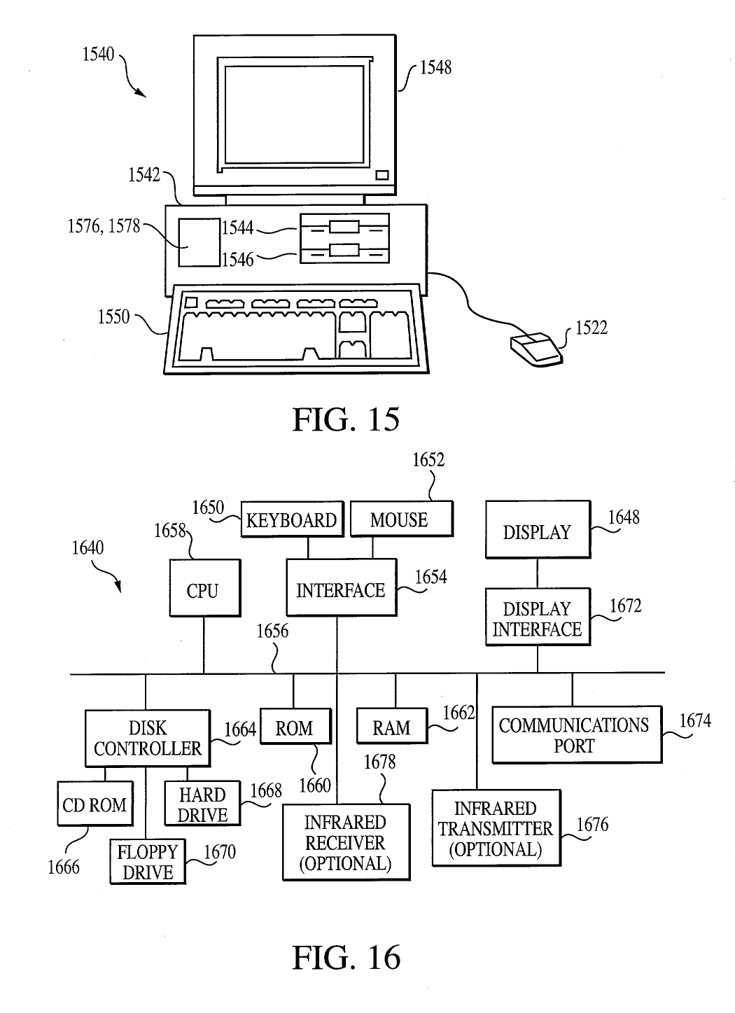

Any number of standard computing devices may be utilized to implement the processes of the present invention. Viewed externally in FIG. 15, a computer system designated by reference numeral 140 has a computer 142 having disk drives 144 and 146. Disk drive indications 144 and 146 are merely symbolic of a number of disk drives which might be accommodated by the computer system. Typically, these would include a floppy disk drive 144, a hard disk drive (not shown externally) and a CD ROM indicated by slot 146. The number and type of drives vary, typically with different computer configurations. Disk drives 144 and 146 are in fact optional, and for space considerations, are easily omitted from the computer system used in conjunction with the production process/apparatus described herein.

The computer system also has an optional display upon which information may be displayed. In some situations, a keyboard 150 and a mouse 152 are provided as input devices through which a user's actions may be inputted, thus allowing input to interface with the central processing unit 142. Then again, for enhanced portability, the keyboard 150 is either a limited function keyboard or omitted in its entirety. In addition, mouse 152 optionally is a touch pad control device, or a track ball device, or even omitted in its entirety as well, and similarly may be used to input a user's selections. In addition, the computer system also optionally includes at least one infrared transmitter and/or infrared received for either transmitting and/or receiving infrared signals, as described below.

FIG. 16 illustrates a block diagram of the internal hardware of the computer system 140 of FIG. 15. A bus 156 serves as the main information highway interconnecting the other components of the computer system 140. CPU 158 is the central processing unit of the system, performing calculations and logic operations required to execute the processes of the instant invention as well as other programs. Read only memory (ROM) 160 and random access memory (RAM) 162 constitute the main memory of the computer. Disk controller 164 interfaces one or more disk drives to the system bus 156. These disk drives are, for example, floppy disk drives such as 170, or CD ROM or DVD (digital video disks) drive such as 166, or internal or external hard drives 168. As indicated previously, these various disk drives and disk controllers are optional devices.

A display interface 172 interfaces display 148 and permits information from the bus 156 to be displayed on the display 148. Again as indicated, display 148 is also an optional accessory. For example, display 148 could be substituted or omitted. Communications with external devices, for example, the other components of the system described herein, occur utilizing communication port 174. For example, optical fibers and/or electrical cables and/or conductors and/or optical communication (e.g., infrared, and the like) and/or wireless communication (e.g., radio frequency (RF), and the like) can be used as the transport medium between the external devices and communication port 174. Peripheral interface 154 interfaces the keyboard 150 and the mouse 152, permitting input data to be transmitted to the bus 156. In addition to the standard components of the computer, the computer also optionally includes an infrared transmitter 178 and/or infrared receiver 176. Infrared transmitters are optionally utilized when the computer system is used in conjunction with one or more of the processing components/stations that transmits/receives data via infrared signal transmission. Instead of utilizing an infrared transmitter or infrared receiver, the computer system may also optionally use a low power radio transmitter 180 and/or a low power radio receiver 182 as shown in the alternate embodiment of FIG. 15. The low power radio transmitter transmits the signal for reception by components of the production process, and receives signals from the components via the low power radio receiver. The low power radio transmitter and/or receiver are standard devices in industry.

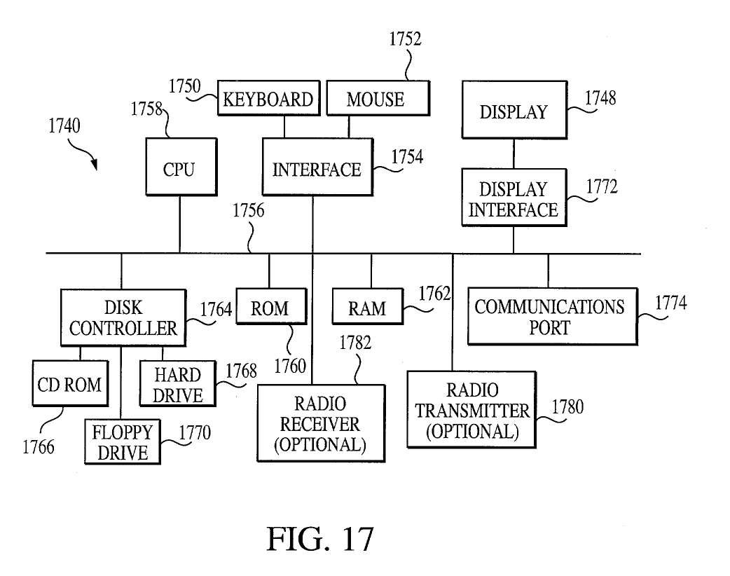

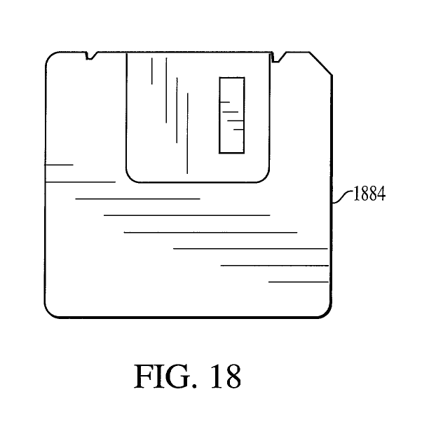

FIGS. 17 is an illustration of an exemplary memory medium 184 which can be used with disk drives illustrated in FIGS. 15-16. Typically, memory media such as floppy disks, or a CD ROM, or a digital video disk will contain, for example, a multi-byte locale for a single byte language and the program information for controlling the computer to enable the computer to perform the functions described herein. Alternatively, ROM 160 and/or RAM 162 illustrated in FIGS. 15-16 can also be used to store the program information that is used to instruct the central processing unit 158 to perform the operations associated with the instant processes.

Although computer system 140 is illustrated having a single processor, a single hard disk drive and a single local memory, the system 140 is optionally suitably equipped with any multitude or combination of processors or storage devices. Computer system 140 is, in point of fact, able to be replaced by, or combined with, any suitable processing system operative in accordance with the principles of the present invention, including sophisticated calculators, and hand-held, laptop/notebook, mini, mainframe and super computers, as well as processing system network combinations of the same.

Conventional processing system architecture is more fully discussed in Computer Organization and Architecture, by William Stallings, MacMillan Publishing Co. (3rd ed. 1993); conventional processing system network design is more fully discussed in Data Network Design, by Darren L. Spohn, McGraw-Hill, Inc. (1993), and conventional data communications are more fully discussed in Data Communications Principles, by R. D. Gitlin, J. F. Hayes and S. B. Weinstain, Plenum Press (1992) and in The Irwin Handbook of Telecommunications, by James Harry Green, Irwin Professional Publishing (2nd ed. 1992). Each of the foregoing publications is incorporated herein by reference. Alternatively, the hardware configuration is, for example, arranged according to the multiple instruction multiple data (MIMD) multiprocessor format for additional computing efficiency. The details of this form of computer architecture are disclosed in greater detail in, for example, U.S. Pat. No. 5,163,131; Boxer, A., Where Buses Cannot Go, IEEE Spectrum, February 1995, pp. 41-45; and Barroso, L. A. et al., RPM: A Rapid Prototyping Engine for Multiprocessor Systems, IEEE Computer February 1995, pp. 26-34, all of which are incorporated herein by reference.

In alternate preferred embodiments, the above-identified processor, and, in particular, CPU 158, may be replaced by or combined with any other suitable processing circuits, including programmable logic devices, such as PALs (programmable array logic) and PLAs (programmable logic arrays). DSPs (digital signal processors), FPGAs (field programmable gate arrays), ASICs (application specific integrated circuits), VLSIs (very large scale integrated circuits) or the like.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for dynamically updating a content list, said method comprising the steps of:
(1) altering said content list at a feed station server by implementing one or more revisions into said content list;
(2) packaging said one or more revisions implemented in step (1) into a message; and
(3) transmitting said message to one or more field stations for updating at least one copy of said content list at said one or more field stations.

2. The method of claim 1, wherein said altering said content list comprises at least one of creating a new content list, or deleting or revising an existing content list.

3. The method of claim 1, wherein said message alters a sequence of stories of said at least one copy of said content list at said one or more field stations.

4. The method of claim 1, wherein said message alters, adds, or deletes at least one of a text element, metadata, or one or more references to media objects, or one or more media objects to said at least one copy of said content list at said one or more field stations.

5. The method of claim 1, wherein said content list is comprised of an ordered sequence of stories, and wherein each story is comprised of at least one text element, metadata, and one or more references to media objects.

6. The method of claim 1, wherein said packaging comprises compressing said message.

7. The method of claim 1, wherein said message includes a timestamp or identifier.

8. The method of claim 1, wherein said step of altering said content list comprises at least one of: adding, revising or deleting at least one of a text element, metadata, or a reference to a media object associated with a story; adding, revising or deleting a new media object; or revising a sequence of stories of said content list.

9. The method of claim 1, wherein said content list comprises one or more references to media objects, wherein said method further comprising the steps of:
resolving said one or more references by obtaining said media objects referenced by said one or more references from a media and object server, wherein each of said media objects includes one or more versions of associated media objects; and
transmitting said media objects to said one or more field stations.

10. The method of claim 1, wherein alterations to said content list at said feed station server are implemented substantially instantaneously to said at least one copy of said content list at said one or more field stations.

11. The method of claim 1, wherein said step of transmitting comprises transmitting a low resolution version of a video object for review at said one or more field stations, said method further comprising:
receiving a request for a high resolution version of said video object from at least one field station; and
transmitting said high resolution version of said video object to said at least one field station.

12. A method for dynamically updating a content list, said method comprising the steps of:
(1) receiving a message transmitted from a feed station server at a field station, wherein said message is comprised of one or more revisions packaged therein implemented at said feed station server; and
(2) updating a copy of said content list maintained at said field station by utilizing said one or more revisions to replace outdated content.

13. The method of claim 12, wherein said content list is comprised of an ordered sequence of stories, and wherein each story is comprised of at least one text element, metadata, and one or more references to media objects.

14. The method of claim 12, wherein said step of updating a copy of said content list comprises at least one of: adding, revising or deleting at least one of a text element, metadata, or a reference to a media object associated with a story; adding, revising or deleting a new media object; or revising a sequence of stories of said copy of said content list.

15. A system for dynamically updating a content list, said system comprising:
a user interface for altering said content list at a feed station server by implementing one or more revisions into said content list;
a packaging module for packaging said one or more revisions into a message; and
a transmitter for transmitting said message to one or more field stations for updating at least one copy of said content list at said one or more field stations.

16. The system of claim 15, wherein said message alters, adds, or deletes at least one of a text element, metadata, one or more references to media objects, or one or more media objects to said at least one copy of said content list at said one or more field stations, or alters a sequence of stories of said at least one copy of said content list at said one or more field stations.

17. The system of claim 15, wherein said content list is comprised of an ordered sequence of stories, and wherein each story is comprised of at least one text element, metadata, and one or more references to media objects.

18. The system of claim 15, wherein said packaging module comprises a compressing module for compressing said message.

19. The system of claim 15, wherein said message includes a timestamp or identifier.

20. The system of claim 15, wherein said user interface is capable of being used to alter said content list by at least one of: adding, revising or deleting at least one of a text element, metadata, or a reference to a media object associated with a story; adding, revising or deleting a new media object; or revising a sequence of stories of said content list.

21. The system of claim 15, wherein said content list comprises one or more references to media objects, wherein said system further comprises:
a resolution module for resolving said one or more references by obtaining said media objects referenced by said one or more references from a media and object server, wherein each of said media objects includes one or more versions of associated media objects; and wherein said transmitter is capable of transmitting said media objects to said one or more field stations.

22. The system of claim 15, wherein alterations to said content list at said feed station server are implemented substantially instantaneously to said at least one copy of said content list at said one or more field stations.

23. The system of claim 15, wherein said transmitter is capable of transmitting a low resolution version of a video object for review at said one or more field stations, and wherein said system further comprises:
a receiver for receiving a request for a high resolution version of said video object from at least one field station; and wherein, in response to receiving said request, said transmitter transmits said high resolution version of said video object to said at least one field station.

24. A system for dynamically updating a content list, said system comprising:
a receiver for receiving a message transmitted from a feed station server at a field station, wherein said message is comprised of one or more revisions packaged therein implemented at said feed station server; and
a processor for updating a copy of said content list maintained at said field station by utilizing said one or more revisions to replace outdated content.

25. The system of claim 24, wherein said content list is comprised of an ordered sequence of stories, and wherein each story is comprised of at least one text element, metadata, and one or more references to media objects.

26. The system of claim 24, wherein said processor updates said copy of said content list by at least one of: adding, revising or deleting at least one of a text element, metadata, or a reference to a media object associated with a story; adding, revising or deleting a new media object; or revising a sequence of stories of said copy of said content list.

27. A system for dynamically updating a content list, said system comprising:
means for altering said content list at a feed station server by implementing one or more revisions into said content list;
means for packaging said one or more revisions into a message; and
means for transmitting said message to one or more field stations for updating at least one copy of said content list at said one or more field stations.

28. The system of claim 27, wherein said message alters, adds, or deletes at least one of a text element, metadata, one or more references to media objects, or one or more media objects to said at least one copy of said content list at said one or more field stations, or alters a sequence of stories of said at least one copy of said content list at said one or more field stations.

29. The system of claim 27, wherein said content list is comprised of an ordered sequence of stories, and wherein each story is comprised of at least one text element, metadata, and one or more references to media objects.

30. The system of claim 27, wherein said means for altering said content list comprises at least one of: means for adding, revising or deleting at least one of a text element, metadata, or a reference to a media object associated with a story; means for adding, revising or deleting a new media object; or means for revising a sequence of stories of said content list.

31. The system of claim 27, wherein alterations to said content list at said feed station server are implemented substantially instantaneously to said at least one copy of said content list at said one or more field stations.

32. A system for dynamically updating a content list, said system comprising:
means for receiving a message transmitted from a feed station server at a field station, wherein said message is comprised of one or more revisions packaged therein implemented at said feed station server; and
means for updating a copy of said content list maintained at said field station by utilizing said one or more revisions to replace outdated content.

33. The system of claim 32, wherein said content list is comprised of an ordered sequence of stories, and wherein each story is comprised of at least one text element, metadata, and one or more references to media objects.

34. The system of claim 32, wherein said means for updating a copy of said content list comprises at least one of: means for adding, revising or deleting at least one of a text element, metadata, or a reference to a media object associated with a story; means for adding, revising or deleting a new media object; or means for revising a sequence of stories of said copy of said content list.

35. A computer readable medium storing instructions executable by a computer, the instructions for instructing the computer to effect dynamically updating a content list, said medium comprising instructions for:
altering said content list at a feed station server by implementing one or more revisions into said content list;
packaging said one or more revisions into a message; and
transmitting said message to one or more field stations for updating at least one copy of said content list at said one or more field stations.

36. The medium of claim 35, wherein said message alters, adds, or deletes at least one of a text element, metadata, one or more references to media objects, or one or more media objects to said at least one copy of said content list at said one or more field stations, or alters a sequence of stories of said at least one copy of said content list at said one or more field stations.

37. The medium of claim 35, wherein said content list is comprised of an ordered sequence of stories, and wherein each story is comprised of at least one text element, metadata, and one or more references to media objects.

38. The medium of claim 35, wherein said instructions for altering said content list comprises at least one of: instructions for adding, revising or deleting at least one of a text element, metadata, or a reference to a media object associated with a story; instructions for adding, revising or deleting a new media object; or instructions for revising a sequence of stories of said content list.

39. The medium of claim 35, wherein alterations to said content list at said feed station server are implemented substantially instantaneously to said at least one copy of said content list at said one or more field stations.

40. A computer readable medium storing instructions executable by a computer, the instructions for instructing the computer to effect dynamically updating a content list, said medium comprising instructions for:
receiving a message transmitted from a feed station server at a field station, wherein said message is comprised of one or more revisions packaged therein implemented at said feed station server; and
updating a copy of said content list maintained at said field station by utilizing said one or more revisions to replace outdated content.

41. The medium of claim 40, wherein said content list is comprised of an ordered sequence of stories, and wherein each story is comprised of at least one text element, metadata, and one or more references to media objects.

42. The medium of claim 40, wherein said instruction for updating a copy of said content list comprises at least one of: instruction for adding, revising or deleting at least one of a text element, metadata, or a reference to a media object associated with a story; instruction for adding, revising or deleting a new media object; or instruction for revising a sequence of stories of said copy of said content list.

43. A system for dynamically updating a content list, said system comprising:
a newsroom computer system for coordinating generation and revision of news information including said content list, wherein said content list is comprised of an ordered sequence of stories, and wherein each story is comprised of at least one of a text element, metadata, and one or more references to media objects;
one or more media and object servers for storing said media objects referenced by said one or more references; and
an object and stream manager for managing transmission of data to one or more client servers including one or more revisions to said ordered sequence of stories of said content list, text element, metadata, references to media objects and media objects retrieved from said one or more media and object servers, wherein said one or more revisions to said content list made at said newsroom computer system are packaged into a message and transmitted to said one or more client servers for updating one or more corresponding content lists at said one or more client servers.

44. The system of claim 43, wherein each of said one or more client servers stores a copy of said content list and is capable of receiving data from said object and stream manager, wherein said one or more revisions, received from said object and stream manager, are transmitted in said message to said one or more client servers.

45. The system of claim 43, wherein each of said one or more client servers comprises a client newsroom computer system for viewing a client server copy of said content list including text elements, metadata, and media objects.

46. The system of claim 43, wherein said object and stream manager further comprises a receiver unit for receiving information from said newsroom computer system.

47. The system of claim 43, wherein said object and stream manager further comprises a file parser for identifying the one or more references to the media objects in said content list.

48. The system of claim 43, wherein said object and stream manager further comprises a storage unit for storing the media objects retrieved from said one or more media and object servers.

49. The system of claim 43, wherein said object and stream manager further comprises a rules module for storing and applying rules to said content list, wherein said rules govern at least a routing of said content list within said system.

50. The system of claim 43, wherein said object and stream manager further comprises an addressing module for generating addressing information for transmitting said content list to appropriate destinations.

51. The system of claim 43, wherein said object and stream manager further comprises a transmit module for utilizing said addressing information provided by said addressing module to transmit said content list.

52. The system of claim 43, wherein said one or more media and object servers are responsible for transmitting media objects to at least one of said object and stream manager for transmission or a user interface of said newsroom computer system for viewing or manipulation.

53. The system of claim 43, wherein said metadata comprises at least one of text, XML markup, and binary information.
